(19) United States
(12) Patent Application Publication
(10) Pub. No.: US 2026/0147083 A1
(43) Pub. Date: May 28, 2026

(54) METHODS, ARCHITECTURES, APPARATUSES, AND SYSTEMS FOR POSITIONING-ASSISTED SENSING

(71) Applicant: InterDigital Patent Holdings, Inc., Wilmington, DE (US)

(72) Inventors: Yasser Mestrah, Uxbridge (GB); Ghyslain Pelletier, Montreal (CA); Arman Shojaeifard, London (GB); Mohammad Heggo, Lewisham (GB); Ibrahim Hemadeh, Hemel Hempstead (GB); Fumihiro Hasegawa, Westmount (CA); Remun Koirala, London (GB); Moon IL Lee, Melville, NY (US); Paul Marinier, Brossard (CA)

(21) Appl. No.: 18/963,327

(22) Filed: Nov. 27, 2024

(51) Int. Cl. G01S 7/00; G01S 13/86; H04W 64/00

(52) U.S. Cl. CPC G01S 7/006; G01S 13/86; H04W 64/00

(57) ABSTRACT

Methods and devices are provided for positioning-assisted sensing. A wireless transmit/receive unit (WTRU) receives configuration information from a wireless network to assist in a sensing operation. The WTRU performs sensing measurements and identifies events that trigger positioning-related actions. Upon detecting such an event, the WTRU executes these actions and conducts additional sensing measurements. Events triggering these actions can include changes in measurements, error types, or mobility of the WTRU. The configuration information may include details like sensing target identifiers and positioning information. The WTRU can also transmit assistance information to the network and receive updates, repeating the process until a termination event is detected. Positioning-related actions may involve performing positioning measurements, indicating positioning methods, or applying enhancements like carrier phased positioning. The method ensures accurate and reliable sensing and positioning by dynamically adapting to detected events and updating measurements accordingly.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

A device (e.g., a wireless transmit/receive unit) that is communicatively coupled to a wireless network may perform sensing-related measurements based on signals from the wireless network. During this process, sensing measurement errors caused by positioning performance may occur.

### SUMMARY

In certain representative embodiments, methods and wireless transmit/receive units (WTRUs) are provided for position-assisted sensing. For example, the WTRU receives configuration information from a wireless network. Also, for example, the configuration information relates to a sensing operation and identifies at least one event that triggers positioning-related actions to assist the sensing operation. Further, for example, the WTRU performs sensing measurements based on this information. In addition, for example, if an event occurs during these measurements, the WTRU performs the positioning-related actions and then conducts additional sensing measurements based on these actions.

Moreover, for example, the event is triggered by various factors, such as changes in sensing measurements, hierarchical measurement dependencies, determined error types or sources, reference or expected values of the measurements, the reliability of the measurements, or the mobility of the WTRU.

Furthermore, for example, the information related to the sensing operation includes a sensing target identifier, positioning information, target type, mobility information, WTRU positioning information, hierarchical measurements and dependencies, error sources, reference measurements, thresholds for validation, reporting assistance information, or a validity time.

Additionally, for example, the WTRU transmits assistance information to the wireless network based on the sensing measurements, receives updated assistance information, and repeats one or more of the process steps if no termination event is detected. Still further, for example, if a termination event is detected, the WTRU transmits a report based on the sensing measurements.

Even further, for example, the positioning-related actions involve performing positioning measurements, indicating a positioning method to the wireless network, performing a joint positioning method, activating carrier phased positioning enhancement, applying fusion of radio access technology and non-radio access technology (RAT) positioning, increasing a positioning measurement window, validating positioning measurements, or determining reporting modes based on the event.

Yet further, for example, the event triggers sensing-related actions to assist the sensing operation. Further still, for example, the WTRU sends uplink assistance information to the wireless network, logs sensing measurements, stops performing sensing measurements, applies a different sensing configuration, enables new measurements, validates measurements, or determines reporting modes based on the event.

Also, for example, the configuration information indicates information related to a positioning operation, leading the WTRU to perform positioning measurements based on this information. Further, for example, the occurrence of an event is determined based on these positioning measurements. In addition, for example, the configuration information identifies events that trigger sensing-related actions to assist the positioning operation. Moreover, for example, if an additional event occurs during positioning measurements, the WTRU performs sensing-related actions and additional positioning measurements based on these actions.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating the impact of positioning error on sensing measurements, according to one or more embodiments;

FIG. 3 is a chart of an example sensing-assisted positioning procedure, according to one or more embodiments;

FIG. 4 is a chart illustrating an example first WTRU procedure that triggers a second WTRU procedure, according to one or more embodiments;

FIG. 5 is a chart illustrating an example of downlink (DL) signaling for WTRU configuration in sensing and positioning under unified network control, according to one or more embodiments;

FIG. 6 is a chart illustrating an example of DL signaling for WTRU configuration in sensing and positioning under separate network control, according to one or more embodiments;

FIG. 7 is a diagram illustrating an example of channel impulse response (CIR) behavior for sensing and positioning using common reference signals (RSs), according to one or more embodiments;

FIG. 8 is a diagram illustrating an example of CIR behavior for sensing and positioning using separate RSs, according to one or more embodiments;

FIG. 9 is a diagram of hierarchal measurement dependency within and between WTRU procedures, according to one or more embodiments;

FIG. 10 is a diagram of error detection using single measurement, according to one or more embodiments;

FIG. 11 is a diagram of joint error detection using multiple measurements, according to one or more embodiments;

FIG. 12 is a diagram of error detection using hierarchal and dependency measurements, according to one or more embodiments;

FIG. 13 is a diagram of an example measurement validation process, according to one or more embodiments;

FIG. 14 is a diagram of different sensing and positioning reporting modes, according to one or more embodiments;

FIG. 15 is a diagram of association between measurement objects and reporting configuration lists that result in a measurement index list, according to one or more embodiments;

FIG. 16 is a chart illustrating an example positioning-assisted sensing procedure using multiple WTRUs and separate network entities to perform sensing and positioning, according to one or more embodiments; and

FIG. 17 is a chart illustrating sample systems and methods for performing positioning-assisted sensing, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

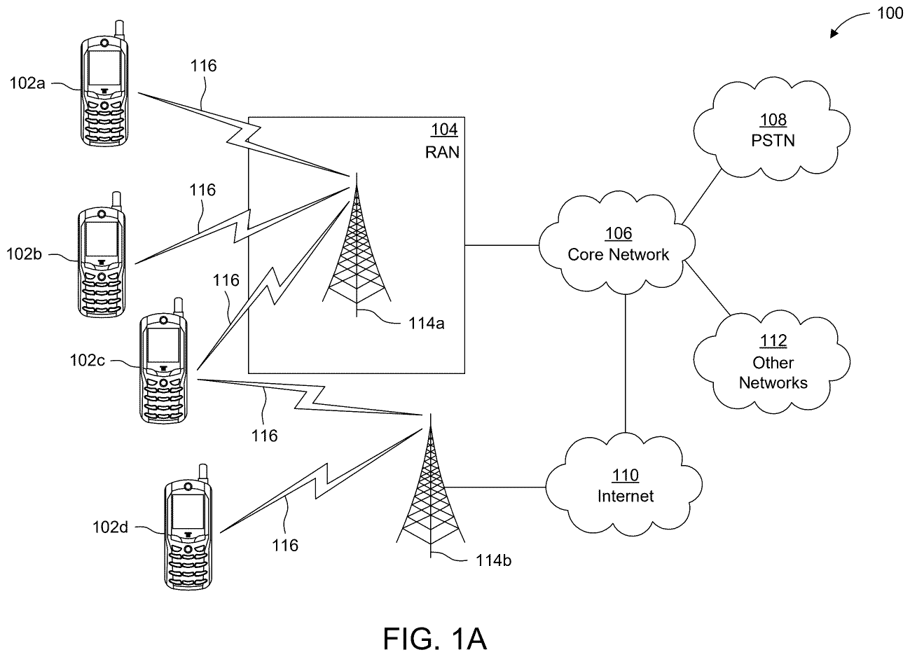

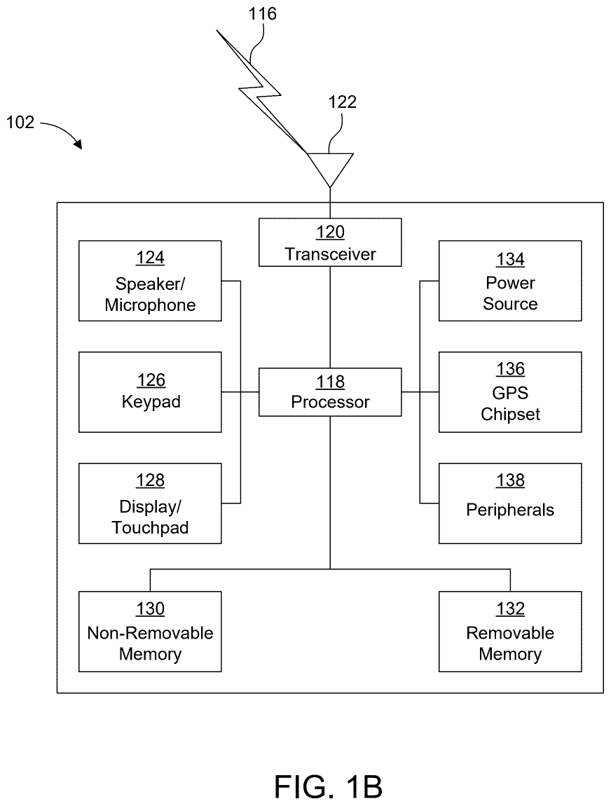

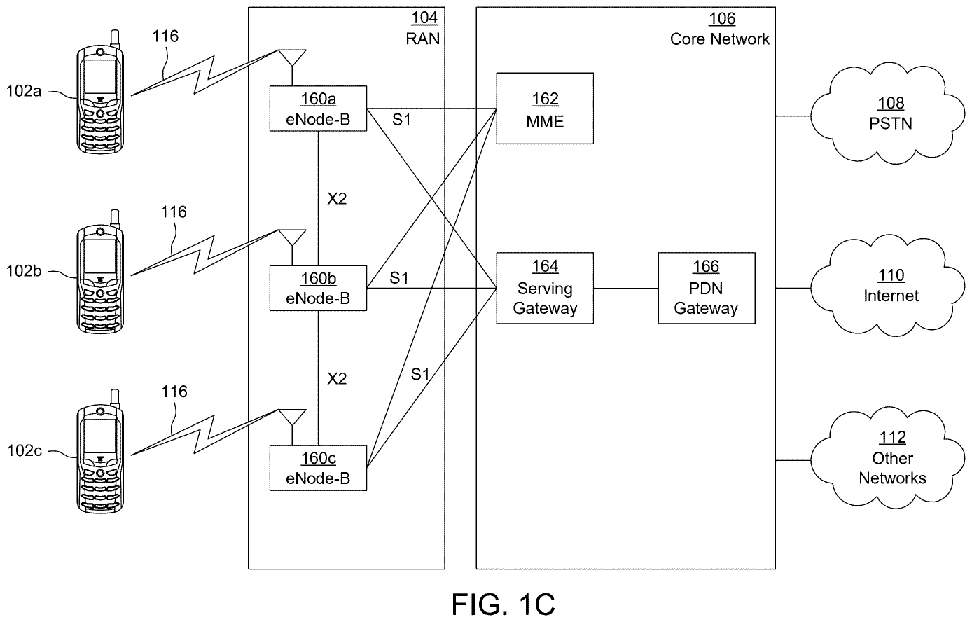

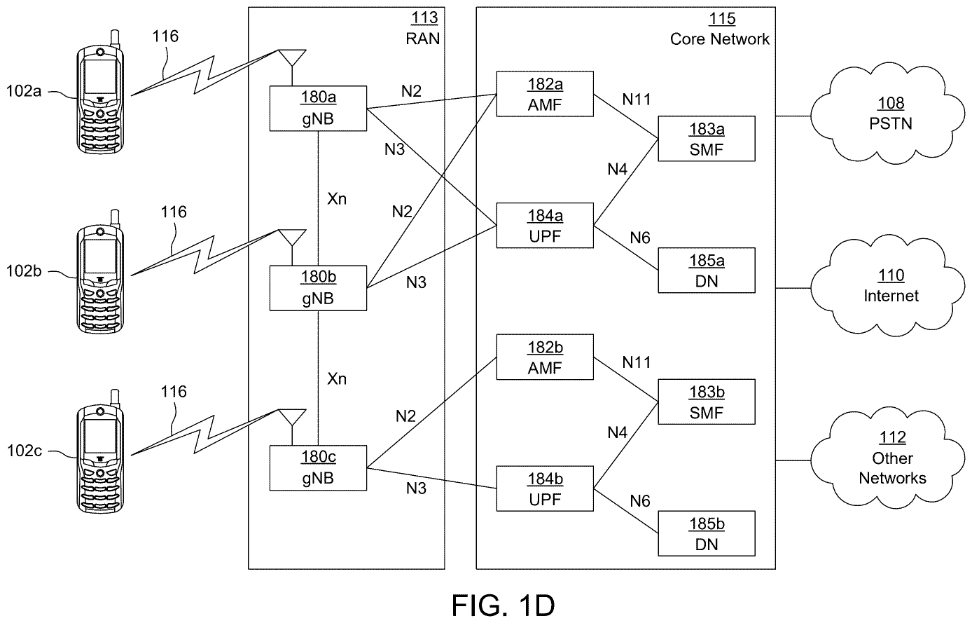

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations (BSs), networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). The frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of the elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of the component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of the elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some approaches, next generation cellular systems (e.g., 5th generation (5G), 5G advance, 6th generation (6G), or the like) utilize higher frequency bands (e.g., mmWave to THz), wider bandwidth, and massive antenna arrays to enable high-accuracy and high-resolution sensing. In such approaches (e.g., ISAC), wireless signal sensing and communication may be integrated into a single system, providing benefits to both functions. For example, the entire communications network may function as a giant sensor, using both transmitted and received radio signals, along with their reflections and scattering, to better understand the physical world. Further, for example, such approaches may extract range, velocity, and angle information from radio signals to enable a wide array of new services, such as high-accuracy localization or positioning.

In some approaches (e.g., sensing frameworks, ISAC, or the like), the target may not be a connected device. Instead, delay, doppler, and angle spectrum information (e.g., indicating the distance, velocity, and angle of the objects) may be obtained from scattered and reflected wireless signals through different sensing modes. For example, sensing modes may include monostatic sensing (e.g., with co-located transmitter and receiver) and/or bistatic sensing (e.g., with non-co-located transmitter and receiver). Further, for example, such approaches process wireless signals to extract the locations, orientations, velocities, and other geometric information of objects in a physical 3D space. In such approaches, the accuracy of WTRU location estimation may directly impact the reliability and accuracy of sensing results. Due to the underlying interdependencies, systems and methods for coordinating the frameworks for positioning and sensing (e.g., positioning-assisted sensing, sensing-assisted positioning) are provided to mutually enhance both operations.

Accordingly, methods, architectures, apparatuses, and systems for assisting a sensing operation with positioning-related actions are provided. For example, methods and systems are provided for WTRU detection and reporting of sensing measurement error that depends on and/or is caused by positioning performance. Also, for example, WTRU behaviors are provided, including applying a certain measurement configuration towards positioning measurement quantity associated with the conditions to improve sensing measurement accuracy and reliability. Further, for example, the WTRU reports sensing in addition to positioning measurements and a validity window.

For example, in accordance with ISAC, positioning, sensing, error source type determination, and/or measurement integrity are provided. Also, for example, the WTRU receives sensing configuration with sensing events (e.g., including conditions) that are triggers for positioning actions, including conditions for reporting, update and termination procedure. Further, for example, the WTRU receives reference signal(s) and performs set of configured measurements. In addition, for example, the WTRU determines error type(s) and source(s) based on positioning and/or sensing measurements. Moreover, the WTRU processes and/or monitors and/or determines event triggers (e.g., for positioning) using sensing and/or positioning measurements. Furthermore, for example, the WTRU performs set of actions towards improving sensing performance (e.g., improving positioning accuracy). Additionally, for example, the WTRU reports to the NW sensing measurements in addition to positioning measurements and a validity window.

For example, the positioning-assisted sensing (e.g., coordination of simultaneous sensing and positioning operations) is provided as part of ISAC. Moreover, for example, a WTRU receives, from a wireless network, configuration information indicating information related to a sensing operation and/or identifying events that trigger positioning-related actions to assist the sensing operation. Further, for example, the WTRU performs sensing measurements based on the information related to the sensing operation. Additionally, for example, the WTRU determines that an event (e.g., that triggers the positioning-related actions) has occurred while performing the sensing measurements. Also, for example, the WTRU, based on determining that the event has occurred, performs the positioning-related actions. Furthermore, for example, the WTRU performs additional sensing measurements (e.g., related to the sensing operation) based on performing the positioning-related actions.

For example, in combination with positioning-assisted sensing, new radio (NR) sensing of targets in the environment is described as follows. Further, for example, the NR sensing includes detecting, estimating, and monitoring conditions (e.g., shape, size, orientation, speed, location, distance, relative motion, or the like) of the environment and/or objects within the environment using NR radio frequency (RF) signals. Additionally, for example, next generation technologies (e.g., 5G advance, 6G) enable highly accurate sensing with high resolution relevant information extraction through high carrier frequencies, large available bandwidth, large number of antennas, device-to-device communications, network densification and/or artificial intelligence/machine learning (AI/ML). Also, for example, NR sensing is categorized into monostatic and bistatic sensing modes based on the transmitter and receiver location. Moreover, for example, channel models for NR sensing and ISAC are defined for object detection and tracking. NR sensing can be viewed as an extension of NR positioning. The reference signals, architectures, signaling frameworks, methods, and protocols defined for positioning may also be applicable to sensing.

For example, in combination with positioning-assisted sensing, NR positioning methods are described as follows. NR positioning methods may differ between DL and UL conditions.

For example, in downlink positioning, positioning reference signal (PRS) resources from multiple transmit-receive points (TRPs) are transmitted to the target WTRU. Further, for example, the signal propagation environment changes some of the properties of the transmitted signal (e.g., signal amplitude, frequency, phase, or the like), which is measured by the WTRU (e.g., as reference signal received power (RSRP), reference signal time difference (RSTD), doppler shifts, or the like). Also, for example, the WTRU, based on the measured properties infers intermediate positioning metrics, e.g., delay between the TRP and the WTRU (e.g., DL-time difference of arrival (TDoA)), angle (e.g., DL-angle of departure (AoD)), combinations of the same, or the like.

For example, in uplink positioning, the sounding reference signal for positioning (SRSp) resources are transmitted by the WTRU to multiple TRPs. Further, for example the TRPs measure each SRSp resource, e.g., to acquire RSRP, RSTD, doppler shift, combinations of the same, or the like. Moreover, for example, the TRPs infer intermediate positioning metrics, e.g., delay between the TRP and the WTRU (e.g., UL-TDoA), angle (e.g., UL-AoA), combinations of the same, or the like.

In some examples, DL and UL positioning are combined such that the TRP transmits the SL-PRS to the WTRU and upon reception of the DL-PRS the WTRU transmits the SRSp. Such approaches may generate a two-way range between the TRP and the target WTRU, eliminating potential TRP-WTRU clock synchronization error issues. In some examples, measurements and metrics at the WTRU or multiple TRPs may be fused together at the WTRU, TRP and/or the network to estimate the location of the target WTRU (e.g., in 2D or 3D coordinates).

For example, in combination with positioning-assisted sensing, NR positioning architectures are described as follows. Further, for example, positioning architecture may include three main entities: the target WTRU, next generation radio access network (NG-RAN) (e.g., including NR gNB, long-term evolution (LTE) NG-CNB TRPs, or the like), and the core network (e.g., 5G core (5GC) including the access mobility function (AMF) and/or location management function (LMF)). Further for example, each of the three entities may assume a role based on whether the positioning is WTRU-based or WTRU-assisted. These roles may include at least one of: requesting and/or transmitting positioning assistance information, requesting and/or transmitting DL-PRS and/or UL-SRS resources, measuring and/or transmitting positioning metrics, measuring and/or transmitting final position estimates, combinations of the same, or the like.

For example, in combination with positioning-assisted sensing, NR positioning protocols are described as follows. Further, for example, interfaces over which messages are transmitted to the different entities include: the next generation control plane (NG-C) interface (e.g., connecting the NG-RAN and the core network); the NR/LTE Uu interface (e.g., connecting the WTRU and the NG-RAN); or the like. Moreover, different signaling protocols for exchanging positioning information and measurements between the entities include: the NR physical resource block (PRB) and path assignment (NRPPa), e.g., between the NG-RAN and the LMF over NG-C interface; radio resource control (RRC), e.g., between the gNB/NG-cNB and the WTRU over the NR/LTE-Uu interface; LTE positioning protocol (LPP), e.g., between the WTRU and the LMF over the NG-C and NR/LTE-Uu interface; combinations of the same; or the like.

In certain representative embodiments, sensing is configured with positioning-related conditions. For example, methods are provided for positioning triggers as a function of sensing measurements. Also, for example, methods are provided for positioning triggers as a function of determined error sources. Further, for example, methods are provided for positioning triggers as a function of positioning events. In addition, methods are provided for at least one of the positioning triggers as the function of sensing measurements, the positioning triggers as the function of determined error sources, the positioning triggers as a function of positioning events, combinations of the same, or the like. Moreover, for example, sensing is performed first, and then positioning is triggered.

For example, a WTRU receives configurations for both sensing and positioning. Also, for example, the WTRU receives configurations for sensing, such as measurement configurations, and for positioning, such as measurement triggers. Further, for example, configurations can be delivered through control messages over various signaling methods, including RRC, MAC-CE, or DCI.

For example, the measurement configurations encompass various types of measurements, such as RSRP, AoA, and ToA, as well as triggers that affect both sensing and positioning. Also, for example, the WTRU categorizing different types of errors as systematic or random, and identifies their sources, which can be time-based or angle-based.

For example, based on determined triggers, the WTRU performs specific actions, such as sending uplink assistance information, logging measurements, or stopping sensing activities. Also, for example, to improve positioning accuracy, the WTRU may suggest better positioning methods based on the identified error types and sources, and the WTRU can execute joint positioning methods. Further, for example, the WTRU determines reporting modes based on the validity of the positioning and sensing measurements and may trigger reports conditioned by the validation of these measurements. In addition, for example, the WTRU can receive reconfiguration messages to update its sensing and positioning configurations. Moreover, for example, one or more of these steps are repeated by the WTRU until a termination event occurs.

In accordance with certain representative embodiments of the present disclosure, relevant terminology is defined as follows.

Systematic error may refer to a consistent, predictable error that skews measurements away from the true value in a specific direction (e.g., positioning error).

Random error may refer to an unpredictable variation in measurements that causes the measurements to scatter around the true value. For example, random error arises from unpredictable fluctuations in the measurement process (e.g., environmental changes, channel variations, or the like).

Hierarchal measurements may refer to measurements organized in a multi-level structure, where each level represents a different degree of detail or aggregation. For example, hierarchal measurements may take the form of structured rules related to hierarchal measurement events that trigger other events and WTRU behaviors (e.g., reporting). In some examples, a hierarchal structure may define radar cross-section (RCS) for sensing as a secondary measurement to the primary measurement of angle of arrival (AoA). For example, an error in the primary measurements (e.g., AoA) propagates to the secondary measurements (e.g., RCS). However, for example, an error in the secondary measurements (e.g., RCS) may not always indicate a problem in the primary measurements (e.g., AoA). Similarly, for example, a hierarchal structure may define RSTD for positioning as a secondary measurement to the primary measurement of time of arrival (ToA). Moreover, for example, a hierarchal structure may indicate that a measurement has no dependencies.

A “TRP” may be used interchangeably with “gNB” or “PRU” or “sensing transmitter” or a “WTRU.” The term “TRP” may be used to indicate an entity (e.g., RAN entity) capable of transmitting a reference signals (e.g., DL-PRS, synchronization signal burst (SSB), channel state information-reference signal (CSI-RS), or the like).

A “WTRU” may be used interchangeably with “sensing receiver” and “UE” and may be used to indicate an entity (e.g., RAN entity) capable of receiving and measuring reference signals (e.g., DL-PRS, SSB, CSI-RS, or the like).

A “network” or “NW” may refer to the AMF, LMF, gNB, NG-RAN, or any other entity involved in sensing functionalities (e.g., SMF).

A “location” may be used interchangeably with “position.” For example, a “location” (e.g., WTRU location, TRP location, or the like) may be expressed in terms of altitude, latitude, geographic coordinate, local coordinate, combinations of the same, or the like.

A “reference signal” or “RS” may refer to any of the positioning and reference signals, e.g., DL-PRS, SRSp, CSI-RS, demodulation reference signal (DM-RS), SSB, or the like.

A “DL-PRS” may refer to any of the downlink positioning or any other reference signals that may be received and/or measured by the WTRU, e.g., SSB, CSI-RS, or the like.

The WTRU may receive configured thresholds from the network (e.g., LMF, gNB, or the like) via a downlink physical channel (e.g., physical downlink shared channel (PDSCH), physical downlink control channel (PDCCH), or the like) or via lower or higher layer signaling (e.g., downlink control indicator (DCI), medium access control-control element (MAC-CE), RRC or LPP message, or the like).

An LMF is a non-limiting example of a node or entity (e.g., network node or entity) that may be used for or to support positioning and/or sensing. Any other node or entity (e.g., server WTRU, sensing management function) may be substituted for the LMF and still be consistent with this disclosure.

An “ID” may be used interchangeably with “index.”

A “path” may be used interchangeably with “multipath.”

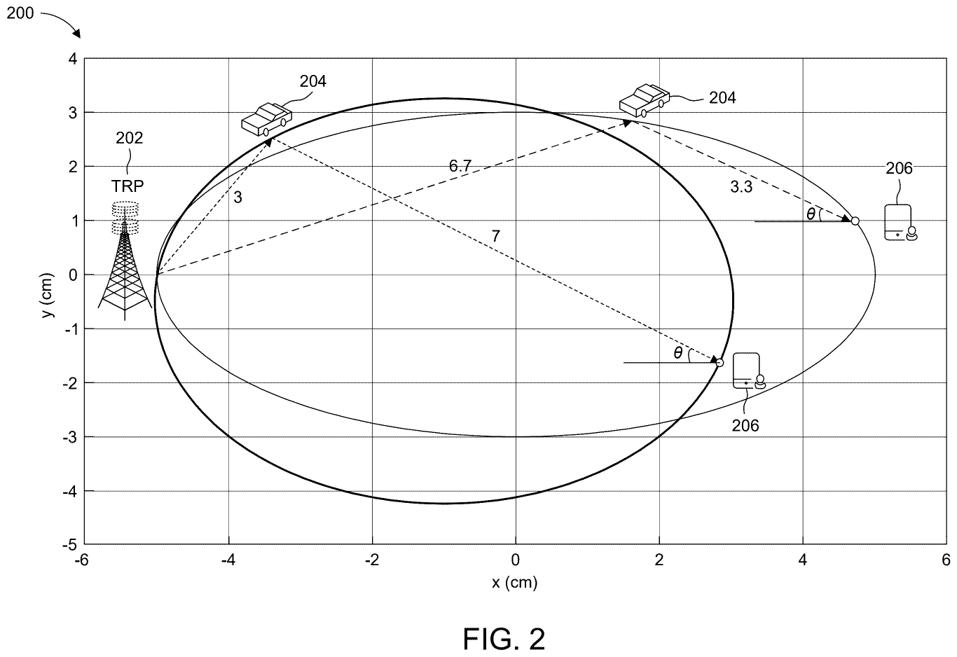

FIG. 2 is a graph 200 illustrating the impact of positioning error on sensing measurements, according to one or more embodiments. As shown in FIG. 2, sensing and positioning accuracy and reliability may be interrelated. For example, when a WTRU 206 performs DL measurements (e.g., sensing measurements) of a target 204, the accuracy of a first procedure (e.g., sensing) may impact the results of a second procedure (e.g., positioning). In some examples, the accuracy of the second procedure (e.g., positioning) may also impact the results of the first procedure (e.g., sensing). Further, for example, WTRU-based measurements, events and related triggers associated to a first RS type (e.g., or a first quantity thereof) may be conditioned by similar WTRU-based behavior based on a second RS type (e.g., or second quantity thereof). Moreover, for example, in FIG. 2, the sensing operation associated with target 204 is related to and/or combined with positioning of WTRU 206 in connection with TRP 202.

For example, in WTRU-assisted sensing, the WTRU is configured to measure and report sensing measurements to the network. Further, for example, in WTRU-assisted positioning, the WTRU is configured to measure and report positioning measurements to the network. However, the sensing may be conditioned on or impacted by positioning, e.g., unreliable sensing measurements, and/or sensing measurements subject to error sources. Thus, WTRU behavior for positioning that is defined as a function of sensing-related WTRU behavior is provided. Accordingly, an example sensing framework that includes events that trigger positioning-related behavior is described herein.

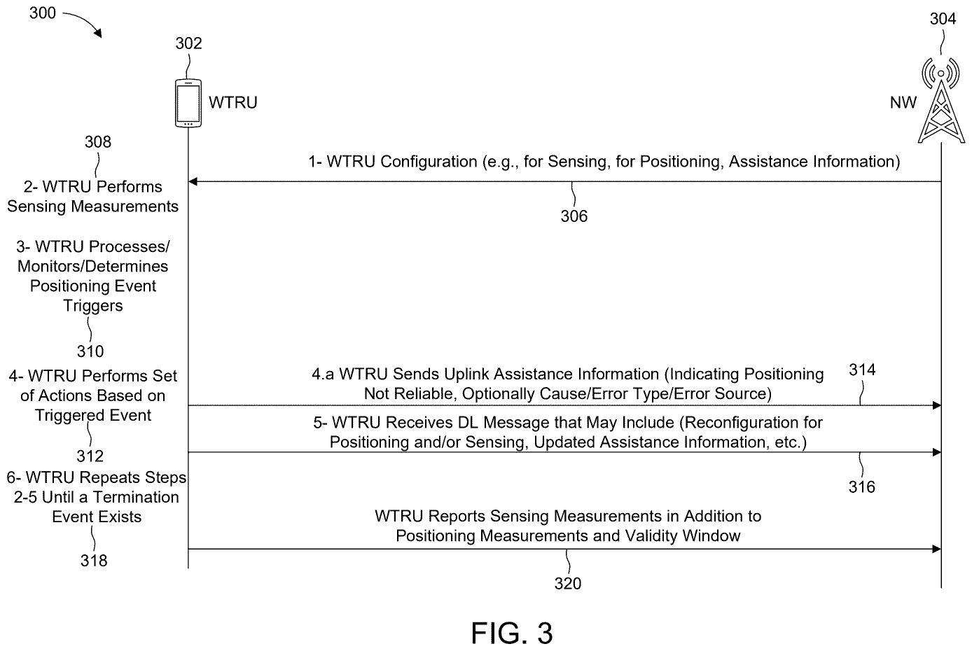

FIG. 3 is a chart 300 of an example sensing-assisted positioning procedure, according to one or more embodiments. As shown in FIG. 3, in certain representative embodiments, the WTRU 302, in connection with network 304, performs sensing and triggers positioning-related actions while performing sensing. For example, the WTRU 302 may trigger positioning-related actions based on at least one of sensing measurements, determined error sources, positioning events, combinations of the same, or the like. Further, for example, the WTRU 302 receives 306 a configuration for sensing (e.g., including a measurement configuration and a measurement object with a measurement ID (measID)) and a configuration for positioning (e.g., including an event trigger that refers to sensing measID). Additionally, for example, the WTRU 302 performs 308 sensing measurements. Also, for example, the WTRU 302 determines 310 an event trigger. Moreover, for example, the WTRU 302 performs 312 one or more actions based on the determined event trigger. Still further, for example, the WTRU 302 may send 314 uplink information to the network 304. Even further, for example, the WTRU 302 may receive 316 a DL message from the network 304 indicating updated assistance or reconfiguration information. The WTRU 302 may repeat 318 one or more of the aforementioned steps until a termination event is determined to exist. Furthermore, for example, the WTRU 320 reports any relevant information (e.g., sensing information, positioning information, or the like) to the network 304.

In certain representative embodiments, the WTRU 302 receives 306 configuration information (e.g., over RRC signaling, MAC-CE, DCI, or the like) including at least one of the following: sensing configuration information, positioning configuration information, sensing assistance information, combinations of the same, or the like. In some examples, the positioning configuration may be a common configuration with sensing to perform both sensing and positioning. In other examples, the WTRU 302 receives 306 a standalone positioning configuration.

For example, the sensing configuration may include measurement configuration information and/or sensing events and/or conditions that are triggers for positioning-related actions. Further, for example, measurement configuration information may include at least one of the following: RSs; measurement periodicity, e.g., periodic, aperiodic (e.g., DCI-triggered), semi-persistent (e.g., MAC-CE activated); measurement triggers; sets of measurements, e.g., RSRP, reference signal received power per path (RSRPP), ToA, AoA, doppler, micro-Doppler (MD), CIR, power delay profile (PDP), or the like; sets of key performance indicators (KPIs), e.g., resolution, accuracy, or the like; combinations of the same; or the like. Additionally, for example, sensing events and/or conditions that are triggers for positioning-related actions may impact at least one of: positioning measurements; configuration for positioning; reporting for positioning, e.g., include sensing measurements with positioning measurements, alternative reporting modes, a higher or lower granularity, or the like; combinations of the same; or the like.

For example, sensing assistance information may include at least one of the following: error types, e.g., systematic, random, or the like; error sources, e.g., time-based, angle-based, channel-based, or the like; error groups, e.g., time error groups, angle error groups, or the like; categorization of error sources and corresponding distributions; hierarchal measurements and dependencies, e.g., including structured rules related to hierarchal measurement events that trigger other events and reports; reference sensing measurements and thresholds for validation, e.g., anchor objects, sensing reference units (SRUs) (e.g., including known location and sensing characteristics), or the like; WTRU location (e.g., absolute or relative) and valid time window; combinations of the same; or the like.

In certain representative embodiments, the WTRU 302, performs 308 sensing measurements of a RS signal. For example, the WTRU 302 may perform 308 sensing measurements with or without an accompanying positioning measurement. Further, for example, the WTRU 302 may perform 308 sensing measurements for a specific period of time, e.g., based on the configuration information received 306 from the network 304 or based on prior configuration of the WTRU 302.

In certain representative embodiments, the WTRU 302 determines 310 an event trigger (e.g., that triggers a positioning-related action). For example, the WTRU 302 may determine 310 the event trigger based on at least one of the following: a set of measurements (e.g., AoA, ToA, RSRP, CIR, RSRPP, RCS, doppler, micro-Doppler, or the like); hierarchal measurement dependencies; a determined error type or source; reference values (e.g., SRUs, anchor objects, or the like) and/or expected values (e.g., coarse object location, or the like); measurement reliability; sensing measurement triggers (e.g., based on positioning accuracy, measurement error source and/or type, mobility); positioning reporting triggers, e.g., based on sensing requirements not being satisfied, systematic measurement error (e.g., positioning error), particular measurement error sources (e.g., angle-based, time-based), or the like; combinations of the same; or the like.

In certain representative embodiments, the WTRU 302 performs 312 one or more actions based on the determined event trigger. For example, the WTRU 302 performs 312 sensing-related actions, positioning-related actions (e.g., to improve sensing by improving positioning accuracy), and/or common actions (e.g., directly related to both sensing and positioning).

For example, sensing-related actions performed by the WTRU 302 may include at least one of the following: sending UL-assistance information (e.g., indicating sensing is not reliable, reporting error of particular type or source); logging sensing measurements (e.g., defining log start time, stop time, what is logged, timeout, behavior after logging, or the like); stopping sensing; applying a different sensing configuration (e.g., a base configuration); enabling a new set of sensing measurements; combinations of the same; or the like.

For example, positioning-related actions performed by the WTRU 302 may include at least one of the following: performing one or more positioning measurements; indicating to the network 304 a better positioning method based on the determined error type and/or error source (e.g., if determined error source is angle-based, a time-based positioning method may be indicated); performing joint positioning method to improve positioning accuracy (e.g., joint positioning method of DL-TDoA and DL-AoD/UL-AoA); activates carrier phased positioning (CPP) enhancement (e.g., over existing positioning method); applying fusion of RAT based and non-RAT based positioning measurements; applying non-RAT positioning (e.g., using global positioning service (GPS); searching for different supporting and/or neighbor cells to perform positioning measurements; collecting more positioning measurements by increasing the positioning window; combinations of the same; or the like. Further, for example, the WTRU 302 may perform CPP enhancement based on determining a time-based error and CPP may require at least one positioning reference unit (PRU) to cancel out WTRU clock offset and mitigate oscillator drift and initial phase error. Moreover, for example, the WTRU 302 may perform CPP enhancement to increase angular resolution based on detecting an angle-based error.

For example, common actions performed by the WTRU 302 may include at least one of the following: validating measurements (e.g., sensing and/or positioning measurements) and determining an associated validity window; triggering a set of reports conditioned by measurement validation; determining a reporting mode as a function of the triggering event (e.g., for sensing and/or positioning reporting); combinations of the same; or the like. Further, for example, the WTRU 302 may report only the sensing report to the network 304 based on determining that the positioning is valid. The WTRU 302 may report the positioning measurements in addition to the sensing report to the network 304 based on determining that the positioning is not valid.

In certain embodiments, the WTRU 302 may receive 316 a DL message from the network 304 including at least one of the following: a reconfiguration for positioning (e.g., a change in positioning method); a reconfiguration for sensing; a reconfiguration (e.g., via RRC) including an add or remove list request (e.g., measID list, measObject list, reportConfig list, or the like); updated assistance information (e.g., for positioning and/or sensing); combinations of the same; or the like.

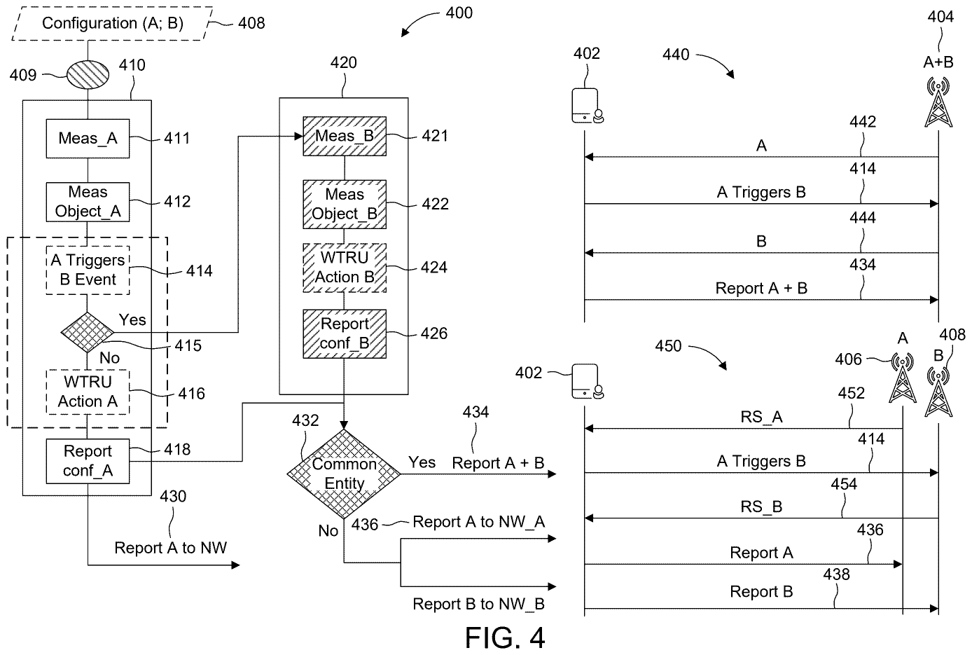

FIG. 4 is a chart 400 illustrating an example first WTRU procedure (e.g., procedure A 410) that triggers a second WTRU procedure (e.g., procedure B 420), according to one or more embodiments. As shown in FIG. 4, in certain representative embodiments, the WTRU 402 in configured (e.g., by TRP 404, 406, and/or 408) with two procedures: procedure A 410 (e.g., sensing) and procedure B 420 (e.g., positioning). For example, before the procedure A 410, initiation and/or priority between configured procedures may be provided at 409 (e.g., the WTRU 402 executes Procedure A 410 first, then triggers Procedure B 420 once the one or more of the defined conditions and/or events are met). Also, for example, the procedure A 410 may include applying a measurement configuration A 411, measuring 412 a reference signal to obtain a measurement (e.g., sensing measurement) of a target, and monitoring for an event trigger 414. Further, for example, the procedure A 410 may trigger procedure B 420 based on determining 414 that the event trigger is satisfied (e.g., 415=“Yes”) or may perform 416 action A based on determining 414 that the event trigger is not satisfied (e.g., 415=“No”). Moreover, for example, procedure A 410 may proceed to generating 418 a report A (e.g., sensing report) and send 430 report A to the network. Also, for example, procedure B 420 may include applying a measurement configuration B 421, measuring 422 a reference signal to obtain a measurement (e.g., positioning measurement) of a target, and performing 424 action B 424. Still further, for example, procedure B 420 may proceed to generating 426 a report B and proceed to decision block 432.

As shown in FIG. 4, in certain representative embodiments, the WTRU 402 may be under unified control by a single TRP (e.g., controlling both procedure A 410 and procedure B 420) or under separate control by multiple TRPs (e.g., a TRP 406 for controlling procedure A 410 and a TRP 408 for controlling procedure B 420). For example, at decision block 432, the WTRU 402 under unified control may send 434 report A and report B to node 404 controlling both procedures (e.g., 432=“Yes”). Further, for example, at decision block 432, the WTRU 402 under separate control may send 436 report A to TRP 406 and send 438 report B to TRP 408 (e.g., 432=“No”).

Chart 440 illustrates an example WTRU 402 performing procedure A 410 and procedure B 420 under unified control of TRP 404. For example, TRP 404 sends 442 the configuration A to WTRU 402 for measurement in procedure A 410. Further, for example, based on receiving an indication of the triggering 414 of procedure B 420, the TRP 404 sends 444 configuration B to WTRU 402 and additionally receives 434 both report A and report B 434 from WTRU 402.

Chart 450 illustrates an example WTRU 402 performing procedure A 410 and procedure B 420 under separate control of TRP 406 and TRP 408. For example, TRP 406 sends 452 reference signal A for measurement by the WTRU 402 during procedure A 410. Further, for example, based on receiving an indication of the triggering 414 of procedure B 420, the TRP 406 sends 454 reference signal B to WTRU 402. Moreover, for example, the WTRU 402 sends 436 report A to TRP 406 and sends 438 report B to TRP 408.

In certain representative embodiments, the WTRU may perform 424 action B based on the event trigger 414 (e.g., associated with procedure A) to improve the measurement accuracy of procedure A 410. For example, WTRU-based measurements and event triggers may associated to a first RS type A (e.g., or a first quantity thereof) and may trigger similar WTRU-based behavior based on a second RS type B (e.g., or a second quantity thereof). Further, for example, some sensing tasks may be related to and/or combined with WTRU positioning.

In accordance with certain embodiments of the present disclosure, configuration of the WTRU for positioning-assisted sensing is described as follows.

In certain representative embodiments, the WTRU receives a configuration from the network that includes an indication to start a sensing task and/or operation (e.g., detection, target localization, tracking, or the like). The WTRU may receive the configuration via RRC signaling, MAC-CE, DCI, or the like). The configuration may include at least one of the following: sensing configuration; positioning configuration; reference signal configuration; reporting configuration; sensing assistance information; WTRU capabilities; initiation procedure; combinations of the same; or the like.

In certain representative embodiments, the sensing configuration includes a sensing measurement task (e.g., detection, tracking, identification, or the like) and corresponding triggers that include at least one of the following parameters: an indication (e.g., a flag) to activate the sensing task; a time window for the sensing task procedure, e.g., starting time, minimum and/or maximum duration, number of measurement occasions for update and termination; measurement configuration information; a sensing window that may be allocated and dependent upon sensing requirements, WTRU capabilities, and/or positioning requirements of the WTRU; triggers for initiating or terminating the sensing task procedure; sensing events that are triggers for positioning; sensing events that affect positioning measurement; sensing events that affect positioning reporting; conditions for activating sensing task with assisted positioning; signaling protocols for exchanging sensing information and measurements and/or report modes; positioning configuration or common configuration (e.g., for both positioning and sensing); combinations of the same; or the like.

For example, measurement configuration information may include at least one of the following: RSs; measurement periodicity, e.g., periodic, aperiodic (e.g., DCI-triggered), semi-persistent (e.g., MAC-CE activated); measurement triggers; sets of measurements, e.g., RSRP, reference signal received power per path (RSRPP), ToA, AoA, doppler, micro-Doppler (MD), CIR, power delay profile (PDP), or the like; sets of key performance indicators (KPIs), e.g., resolution, accuracy, or the like; combinations of the same; or the like.

For example, types of sensing events that are triggers for positioning may include at least one of the following: determined error type, determined error source, event-based triggers, location-based triggers, QoS-based triggers, time-based triggers, mobility-based triggers, combinations of the same, or the like. Further, for example, the WTRU initiates or terminate positioning based on determining a systematic error but instead requests configuration modification (e.g., using an on-demand PRS request) based on determining the error type is random. Moreover, for example, the WTRU terminates a time-based positioning method and initiates an angle-based positioning method based on determining that the error source is time-based. Additionally, for example, the WTRU initiates or terminates positioning procedure measurements when certain signal parameters (e.g., peak to side lobe, or the like) fall below configured thresholds. Still further, for example, the WTRU initiates or terminates positioning procedure measurements when the WTRU enters or leaves certain geographical area, or when it detects proximity to a particular target or location. The geographical area configured for positioning may be similar or different to the geographical area configured for sensing. Also, for example, the WTRU initiates positioning procedure measurements to improve the sensing accuracy based on the sensing accuracy not matching the QoS requirements. Additionally, for example, the WTRU initiates or terminates positioning measurement updates at predefined intervals in order to enable periodic updating. Furthermore, for example, the WTRU initiates or terminates positioning procedure measurements based on a measured WTRU velocity being above or below a threshold value and/or within a range of threshold values.

In one example, a sensing event that affects positioning measurement configuration may be an error source in the sensing measurements (e.g., measurement set A) that is determined to activate a particular set (e.g., measurement set B) of positioning measurements.

For example, event triggers that impact positioning reporting include at least one of the following: conditions for when to consider sensing measurements with positioning measurements; conditions for what to include in the positioning-assisted sensing report; conditions for different report modes; association conditions between sensing measurement objects and positioning measurement objects; granularity level; signaling protocols for exchanging sensing and positioning information and measurements (e.g., the destination for each report mode); combinations of the same; or the like.

In one example, a condition to activate the sensing task with assisted positioning is based on a determined reliability of the sensing and/or positioning measurements. For example, the WTRU is configured with an indication (e.g., a flag) to activate the sensing task with the event triggers (e.g., related to the positioning-related actions) based on whether the sensing and/or positioning measurements are reliable. Further, for example, the WTRU may receive a request from the network (e.g., via MAC-CE) to activate one or more of the event trigger conditions (e.g., related to the positioning-related actions).

In certain representative embodiments, the positioning configuration includes a positioning measurement (e.g., positioning method) and corresponding triggers that include at least one of the following parameters: an indication (e.g., a flag) to activate the positioning task; a time window for the positioning procedure, e.g., starting time, minimum and/or maximum duration, number of measurement occasions for update and termination, or the like; RS resource information for positioning (e.g., all available antenna ports from one or more relevant TRPs); triggers for initiating or terminating the positioning procedure and/or reconfiguration for positioning; signaling protocols for exchanging positioning information and measurements and/or reporting modes; combinations of the same; or the like.

For example, RS resource information may contain at least one of the following parameters: inherited parameters (e.g., inherited from the associated bandwidth part (BWP), common across all resource sets); tuned parameters (e.g., sub carrier spacing (SCS), cyclic prefix, transmission bandwidth, point A offset, or the like); read-only parameters, e.g., assigned depending on numerology tuned parameters (e.g., symbols per slot, slots per subframe, slots per frame); resource set (e.g., multi-slot) level; resource (e.g., within a slot) level; transmission power; type of PRS (e.g., periodic, semi-persistent, aperiodic); spatial relation; quasi-co-location (QCL) information (e.g., QCL target, QCL source) for PRS; number of PRUs; number of TRPs; absolute radio frequency channel number (ARFCN); number of frequency layers; start and/or end time for PRS transmission; on and/or off indicator for PRS; TRP ID; PRS ID; cell ID; global cell ID; PRU ID; applicable time window; combinations of the same; or the like. In some examples, the WTRU applies a PRS configuration under a condition that the current time is within the applicable time window.

For example, resource set (e.g., multi-slot) level parameters are related to PRS configuration and configures the multi-slot level, resource sets, gaps between PRS slots, and/or the periodicity and density of PRS resources within a period. Further, for example, resource set parameters are common for all resource sets and include at least one of: PRS resource set period, resource set slot offset, PRS resource repetition factor, resource time gap, muting pattern (e.g., option 1 and 2); muting bit repetition factor; combinations of the same; or the like.

For example, resource (e.g., within a slot) level parameters enable controlling the resources at the granularity level of individual resource elements (REs) within a resource or slot in time and/or frequency. Further, for example, each DL PRS resource may be identified by a DL PRS sequence ID and associated with a certain spatial transmission direction of DL PRS from a given TRP (e.g., beam) and characterized by configurable parameters. Moreover, for example, some of these parameters are configured for each or all resources in a resource set. Additionally, for example, resources level parameters may be related to time (e.g., number of PRS symbols, symbol start for each resource in a resource set) and/or frequency (e.g., number of physical resource blocks (PRBs) per resource, PRB offset relative to carrier resource grid, common comb size for all PRS resources, RE offset of each PRS resource, frequency offset table, or the like).

In certain representative embodiments, the reference signal configuration includes information about the reference signal resources described as follows.

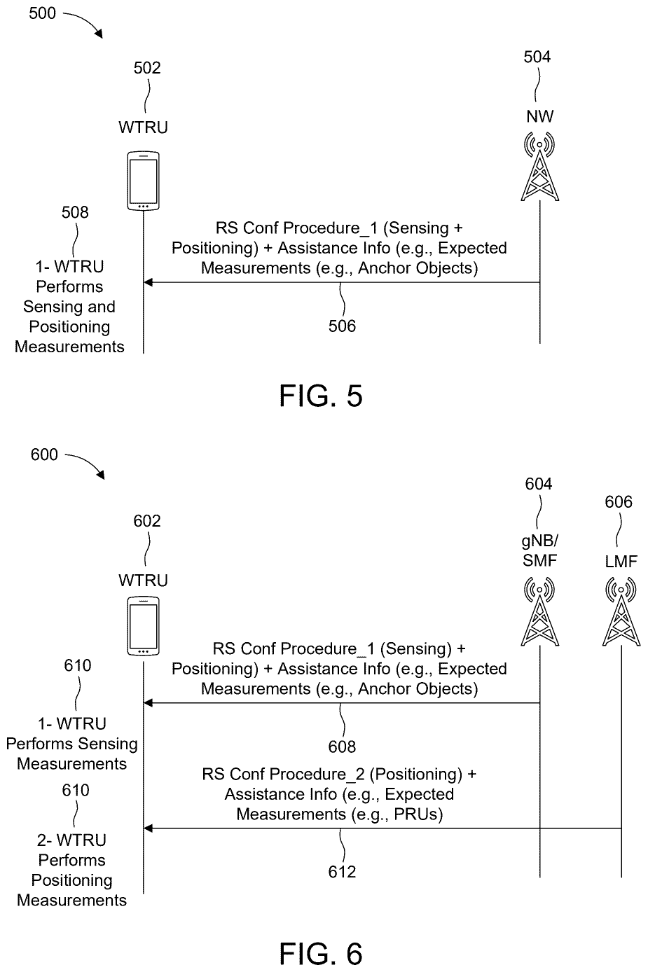

FIG. 5 is a chart 500 illustrating an example of DL signaling 506 for configuration of a WTRU 502 for sensing and positioning under unified network control, according to one or more embodiments. As shown in FIG. 5, for example, an RS is used to perform both sensing and positioning (e.g., DL PRS) sent 506 to the WTRU 502 by node 504 of the wireless network. In this example, the unification may simplify the system design and reduce the overhead associated with managing multiple signals, leading to more efficient use of resources. Further, for example, the NW node 504 may include a gNB, LMF, or the like, that coordinates both sensing and positioning. Additionally, for example, the WTRU 502 may receive 506 a combined configuration to perform 508 sensing and positioning measurements. Moreover, for example, the combined configuration may have impacts on RS configuration, measurement configuration information including common measurements used for sensing and positioning, event triggers, triggered actions, assistance information, thresholds, or the like.

FIG. 6 is a chart 600 illustrating an example of DL signaling for configuration of a WTRU 602 for sensing and positioning under separate network control, according to one or more embodiments. As shown in FIG. 6, in some embodiments, a RS is configured for each task, with one RS dedicated to sensing (e.g., CSI-RS, sensing RS, or the like) and another RS dedicated to positioning (e.g., DL-PRS, or the like). In such embodiments, the separation of RS by task enables the design of each signal according to its specific requirements, potentially enhancing the accuracy and performance of both sensing and positioning functions. For example, the network node 604 (e.g., gNB, SMF, or the like) may send 608 a sensing configuration (e.g., including the RS dedicated to sensing and/or assistance info) to the WTRU 602. Further, for example, the WTRU 602 may perform 610 sensing measurements based on the received sensing configuration. Additionally, for example, the network node 606 (e.g., LMF, or the like) may separately send 612 a distinct positioning configuration (e.g., including the RS dedicated to positioning and/or assistance info) to the WTRU 602. Moreover, for example, the WTRU 602 may perform 614 positioning measurements based on the received positioning configuration. In some examples, communication between the sensing node 604 and the positioning node 606 may be required. Furthermore, for example, the separate configurations may impact RS configuration, measurement configuration, event triggers, triggered actions, or the like.

In certain representative embodiments, a measurement window associated with reference signal configuration for sensing and/or positioning is defined based on at least one of the following: length (e.g., absolute, relative to the target size, or the like); start or end time of the window (e.g., in terms of symbol index, slot index, frame index, absolute time, relative time with respect to a reference point, or the like); duration of the window (e.g., in terms of number of symbols, slots, frames, subframes, seconds, or the like); triggers for activating and/or deactivating the measurement window; triggers for increasing and/or decreasing the length of the measurement window; combinations of the same; or the like.

In certain representative embodiments, the reporting configuration may include at least one of the following: reporting periodicity information; reporting resources, e.g., uplink resources such as transmission power, resource blocks, and scheduling information; conditions for reporting sensing measurements in addition to positioning information (e.g., event-based, time-based, threshold-based); conditions for content included in the positioning-assisted sensing report and positioning-assisted sensing report format; timing reporting granularity factor; retroactive association mechanics between one or more sensing reports (e.g., and/or sensing objects) and one or more positioning reports (e.g., and/or positioning objects) (e.g., start, stop, association method, associated reports and/or objects, or the like); signaling protocols for exchanging sensing and positioning information, and measurements (e.g., including the destination for each reporting mode); reporting ID; combinations of the same; or the like.

For example, the reporting periodicity may include at least one of the following: a type (e.g., periodic, aperiodic, semi-persistent, or the like); period time between successive reports (e.g., for periodic and semipersistent reporting types); report types associated to each periodicity type (e.g., report x is periodic, while report y is semipersistent); combinations of the same; or the like.

For example, conditions for content included in the positioning-assisted sensing report and positioning-assisted sensing report format may include at least one of the following: whether the data is raw or processed; whether the data is statistical or instantaneous; detection of particular events; particular actions performed by the WTRU, time granularity, measurement window, combinations of the same; or the like. Further, for example, the report contents and format may include at least one of the following: primary measurement related information (e.g. sensing measurement information); primary measurement related information (e.g. sensing measurement information) in addition to secondary measurements (e.g., positioning measurement information); a specific source (e.g., angle, time, phase, channel, or the like) of primary and/or secondary measurements; raw and/or processed data; statistical and/or instantaneous data; detected event triggers, e.g., systematic error associated with positioning error; WTRU actions performed; a measurement window; a recommendation or request of a certain reconfiguration; combinations of the same; or the like.

For example, the timing reporting granularity factor may be configured based on the sensing measurement, determined error type, and/or determined error source. In one example, if the determined error type is systematic, the timing reporting granularity factor is x. In another example, if the determined error type is random, the timing reporting granularity factor is y. In another further example, if the determined error source is angle-based, the timing reporting granularity factor is z. For example, the timing reporting granularity factor may be configured based on at least one of the following: RS metrics (e.g., RSRP, RSRPP, CIR, signal-to-interference-plus-noise ratio (SINR), reference signal received quality (RSRQ), or the like); required quality of sensing, a predefined power saving mechanism; combinations of the same; or the like.

For example, the reporting ID may include at least one of the following: a sensing measurement ID; a positioning measurement ID; a RS ID (e.g., RS_1 for sensing, RS_2 for positioning, RS_3 for sensing and positioning); target IDs; combinations of the same; or the like.

In certain representative embodiments, the network provides the WTRU with sensing assistance information that includes parameters to aid in performing sensing and positioning measurements. For example, the WTRU may receive the assistance information associated with a sensing task and/or operation from the network. Further, for example, the WTRU may receive the sensing assistance information semi-statically (e.g., via LPP or RRC messages) and may either be initiated upon the request by the network or sent uninitiated. The assistance information may consist of at least one of the following: a sensing target identifier; sensing target positioning information; sensing target type (e.g., unmanned aerial vehicle (UAV), human, drone, autonomous ground vehicle (AGV), or the like); sensing target mobility information; WTRU positioning information; hierarchal measurements and dependencies; error source and/or type determination procedures; mechanics for logging erroneous sensing measurements (e.g., conditions, duration, actions upon resuming, activation, termination, timeout, actions upon termination, or the like); reporting assistance information; validity time for sensing assistance information; error handling and re-sensing strategies; combinations of the same; or the like.

For example, the sensing target identifier may be associated to the target type (e.g., human, vehicle, rocks, or the like) and/or the location. In one example, the identifiers for targets of a shared type and/or location are selected from different pools. In another example, the identifiers for targets of a shared type are selected from the same pool.

For example, sensing target positioning information may include at least one of the following: target positioning reference information (e.g., SRUs); target coarse location (e.g., location provided as an area defined between certain coordinates, cell IDs, sector IDs, or the like); statistical distribution for one or more measurements (e.g., AoA follows uniform distribution defined in degrees or radians); range of values for one or more measurements (e.g., velocity may be between 3.2-6.4 km/hour for a walking human); combinations of the same; or the like. Further, for example, the target positioning reference information may be absolute (e.g., target coordinates (x; y; z;)) or relative (e.g., with respect to the coordinates and/or orientation of the TRP and/or WTRU). In one example, the WTRU receives the target positioning and/or orientation information relative to the WTRU location.

For example, the sensing target type may be represented by at least one of the following: RCS profile, MD profile, measurement ranges, measurement distributions, measurement rate of change, combinations of the same, or the like.

For example, sensing target mobility information may be absolute (e.g., target velocity, doppler frequency, or the like), relative (e.g., with respect to the WTRU and/or TRP velocity), and/or include an uncertainty range (e.g., velocity and/or doppler frequency uncertainty).

For example, WTRU positioning information may include at least one of the following: WTRU positioning reference information (e.g., PRUs); WTRU coarse location (e.g., location provided as an area defined between certain coordinates, cell IDs, sector IDs, or the like); statistical distribution for one or more measurements (e.g., AoA follows uniform distribution between 35-68 degrees and may also be defined in radians); range of values for one or more measurements (e.g., RSTD may be a value between 1-2 ms); combinations of the same; or the like. Further, for example, the WTRU positioning reference information may be absolute (e.g., target coordinates (x; y; z;)) or relative (e.g., with respect to the coordinates and/or orientation of the TRP and/or WTRU). In one example, the WTRU receives the WTRU and/or TRP positioning and/or orientation information in order to assist the WTRU to calculate the target location relative to the WTRU and/or TRP locations.

For example, the hierarchal measurements and dependencies may include structured rules related to hierarchal measurement events that trigger other events and reports. In some examples, the rules are between sets of measurements under the same procedure (e.g., sensing measurements). For example, AoA and RCS are both sensing measurements and the rules indicate that the secondary measurement RCS depends on the primary measurement AoA. Further, for example, an error in the primary measurement AoA always propagates to the secondary measurement RCS but an error in the secondary measurement RCS does not always indicate a problem an error in the primary measurement AoA. In other examples, the rules are between two different procedures (e.g., between sensing measurements and positioning measurements). For example, the secondary measurement ToA for sensing (e.g., non-line of sight (NLOS)) depends on the primary measurement ToA for positioning (e.g., line of sight (LOS)). In some examples, the rules are structured based on measurement type (e.g., angle-based, time-based, or the like). For example, the secondary measurement AoA for sensing depends on the primary measurement AoA for positioning. In other example, the measurements are treated as the baseline and the rules do not indicate any dependencies between the measurements.

For example, error source and/or type determination procedures may be based on at least one of: one or more measurements to be used, corresponding measurement distributions, number of samples per decision, granularity level, thresholds to be compared, sensing time window, positioning time window, additional processing of measurements, rules for error type classification and determination, rules for error source categories, combinations of the same, or the like.

In some examples, the reporting assistance information may include information for association to the sensing measurement ID. For example, the sensing target ID may be the same or a part of the target ID and/or associated to one or more sensing measurement IDs. Also, for example, multiple sensing target IDs may be associated to one or more sensing measurement IDs. In some examples, the reporting assistance information may include information for association to the sensing measurement ID and positioning measurement ID. For example, the positioning measurement ID may be the same or a part of the sensing measurement ID and/or associated to one or more positioning measurement IDs. Moreover, for example, multiple sensing measurement IDs may be associated to one or more positioning measurement IDs.

For example, the validity time may refer to the total time duration when the sensing assistance information that is provided by the network can be associated to the target. Further, for example, the validity time may be configured in terms of number of symbols, slots, frames, subframes, seconds, or the like.

In some examples, the WTRU transmits the UL sensing assistance information to the network uninitiated (e.g., without an indication from the network). For example, the WTRU may transmit the UL sensing assistance information uninitiated based on determining at least one of the following: the positioning methods supported may assist the network in allocating the positioning configuration; the determined error sources in the sensing measurements may assist the network in allocating the right positioning method; indicating the measurements in error may assist the network in allocating the right resources for positioning for similar and/or dependent measurements; combinations of the same; or the like.

In certain representative embodiments, the WTRU receives and decodes a first network request (e.g., received through RRC signaling) to provide capability information. For example, the WTRU receives and decodes the request following the random-access procedure. Further, for example, the WTRU prepares a capability information message including at least one of the following: sensing processing capabilities (e.g., sensing modes, inverse frequency transform capabilities, maximum number of samples, or the like); sensing-related capabilities; positioning-related capabilities and/or processing capabilities (e.g., supported positioning methods, measurements, determination of error sources and/or inaccuracies, reporting modes, or the like). Moreover, for example, sensing-related capabilities may include at least one of the following: sensing modes; sensing bandwidth; sensing frequency ranges; sensing spatial resolution; sensing time resolution; sensing angular resolution; sensing doppler resolution; phase resolution; sensing measurements; support of half-duplex or full duplex for subject to sensing mode; reflectivity sensitivity (e.g., the minimum power, signal-to-noise ratio (SNR), absolute amplitude, or the like for the reflections to be detectable by the WTRU), reporting modes; combinations of the same; or the like. In some examples, the WTRU sends the WTRU capability information message through RRC signaling, e.g., over the physical uplink shared channel (PUSCH).

In certain representative embodiments, the WTRU receives triggers for initiating the positioning-assisted sensing procedure as a part of the first configuration (e.g., sensing configuration) received from the network. For example, the WTRU may monitor triggers (e.g., time-based, event-based, location-based, mobility-based, QoS-based, or the like) and upon the detection of a trigger, the WTRU may activate, deactivate, receive, request, and/or suggest a positioning and/or sensing configuration to initiate positioning-assisted sensing. Further, for example, the positioning-assisted sensing procedure may be initiated explicitly via UL signaling (e.g., RRC signaling, MAC-CE, dedicated DCI, uplink control information (UCI), reference signal transmissions, LPP messages, or the like) or initiated implicitly through selection of certain UL resources (e.g., resources related to physical random-access channel (PRACH), physical uplink control channel (PUCCH), PUSCH, spatial relation info, or the like).

In some examples, the WTRU may receive a first configuration from the network to initiate positioning-assisted sensing and additionally report sensing and positioning information based on conditions within the initial configuration being satisfied. For example, the WTRU may request for another positioning and/or sensing configuration from the network based on determining an error (e.g., type and/or source) and/or that the sensing measurement is not reliable. Further, for example, the WTRU may receive another positioning and/or sensing configuration from the network to improve sensing task reliability or QoS. Also, for example, the configuration may include an additional set of measurements and/or assistance information not included in the first configuration as well as more granular information for WTRU assistance. Furthermore, for example, the WTRU may receive a request from the network to activate the positioning-assisted sensing procedure.

In accordance with certain embodiments of the present disclosure, systems and methods for performing measurements with the WTRU are described as follows.

In certain representative embodiments, the WTRU performs sensing measurements based on a received a sensing configuration including a set of RS resources (e.g., a SSB, CSI-RS, PRS, a dedicated RS for sensing, or the like). For example, the WTRU may perform the configured measurement in the allocated measurement time window indicated to the WTRU. Further, for example, the time window configuration may include at least one of the following: a start or end time of the window (e.g., in terms of symbol index, slot index, frame index, absolute time, relative time with respect to a reference point, or the like); a duration of the window (e.g., in terms of number of symbols, slots, frames, subframes, seconds, or the like); periodicity of the window (e.g., in terms of number of symbols, slots, frames, subframes, seconds, or the like); combinations of the same; or the like.

For example, the WTRU may be configured by the network to measure at least one of the following using the associated time from the resources: ToA, TDoA, AoA, absolute or relative RSRPP, reference signal carrier power (RSCP), doppler spectrum, MD, RCS, combinations of the same, or the like. Further, for example, the WTRU may be configured by the network to estimate the reliability or quality of one or more of the sensing measurements based on indicating at least one of the following: the degree of proximity of one or more of the sensing measurements to a reference threshold or a mean of a predefined distribution; the degree of proximity of multiple measurements to each other (e.g., the spread of measurements); the degree of proximity of the measurements under same channel conditions; the dependability of measurements over time (e.g., correlation property); the stability of the measurements under certain conditions; combinations of the same; or the like.

For example, the WTRU may activate and/or apply a new configuration for a second type (e.g., dependent) measurement (e.g., positioning-assisted sensing). Further, for example, the new configuration may be associated to the characteristics of an error (e.g., error type and/or error source). The new configuration may cause the WTRU to apply at least one of the following: a different sensing measurement granularity; different measurement quantity and/or methods; different set of sensing measurements (e.g., only common measurements with positioning measurements); combinations of the same; or the like.

In certain representative embodiments, the WTRU performs positioning measurements based on a received positioning configuration including a set of RS resources for positioning (e.g., DL-PRS or the like). For example, the WTRU may perform the configured measurement in the allocated measurement time window indicated to the WTRU. Further, for example, the time window configuration may include at least one of the following: a start or end time of the window (e.g., in terms of symbol index, slot index, frame index, absolute time, relative time with respect to a reference point, or the like); a duration of the window (e.g., in terms of number of symbols, slots, frames, subframes, seconds, or the like); periodicity of the window (e.g., in terms of number of symbols, slots, frames, subframes, seconds, or the like); combinations of the same; or the like.

In some examples, the WTRU is configured by the network to measure at least one of the following using the associated time from the resources: ToA, RSTD, AoA, absolute or relative RSRPP, combinations of the same, or the like. In some examples, the WTRU is configured by the network to perform the set of positioning measurements based on one or more RAT-based positioning methods. For example, the WTRU may be configured by the network to apply a defined set of measurements, number of samples, granularity level, measurement window, or the like per-positioning method. Further, for example, the WTRU may be configured by the network to estimate the reliability of one or more of the positioning measurements.

In certain representative embodiments, the WTRU may be configured with a common RS to perform both sensing and positioning measurements. Table 1 is a measurement table for different measurement procedures categorized based on measurement type.

TABLE 1

| Measurement | Positioning | | Common |
|---|---|---|---|
| category | measurements | Sensing measurements | measurements |
| Timing-based | ToA (e.g., first path), | ToA (e.g., NLOS), | |
| | RSTD, WTRU/gNB | RSTD (e.g., 2nd path), | |
| | receive-transmit (Rx − Tx) | WTRU/gNB/target Rx − | |
| | time difference | Tx time difference | |
| Angle-based | azimuth (Az)-AoA, | Az-AoA, Ze-AoA, Az- | Az-AoA, Ze-AoA, |
| | zenith (Ze)-AoA, Az- | AoD, Ze-AoD, | Az-AoD, Ze-AoD |
| | AoD, Ze-AoD | incident angle | |
| Power-based | RSRP, RSRPP | RSRP, RSRPP, RCS, | RSRP, RSRPP |
| | | peak to sidelobe | |
| Channel-based | CIR, PDP, delay profile | CIR, PDP, DP | CIR, PDP, DP |
| | (DP) | | |
| Target-based | | RCS, MD | |
| Phase-based | DL RSCP; DL RSCP-D | Doppler estimation | |

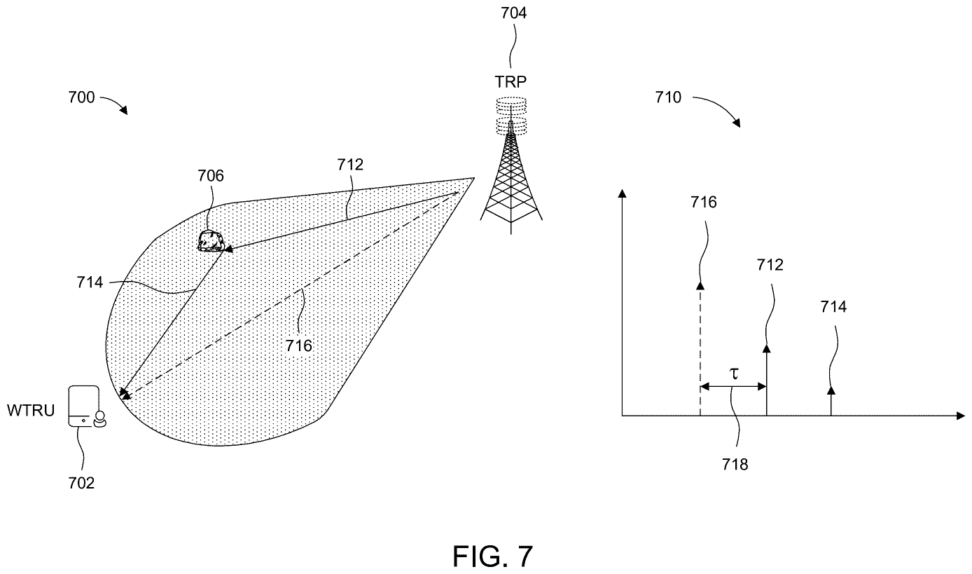

FIG. 7 is a diagram 700 illustrating an example of CIR behavior for sensing and positioning using common RSs, according to one or more embodiments. As shown in FIG. 7, in some examples, the WTRU 702 is configured with time and frequency resources to perform configured measurements related to sensing and/or positioning of a target object 706 on a common RS in connection with a TRP 704. For example, the WTRU 702 may receive the single RS to perform sensing and positioning and may obtain configured measurements through channel impulse responses for sensing and positioning. Further, for example, the WTRU 702 may perform positioning measurements on a LOS path (e.g., first path 716) and sensing measurements along a NLOS path (e.g., second path consisting of 712 and 714) may be measured with respect to the LOS path of the channel impulse response. As shown in graph 710, the WTRU 702 may determine a difference 718 between the channel impulse response of the first path 716 and the channel impulse response of the second path 712.

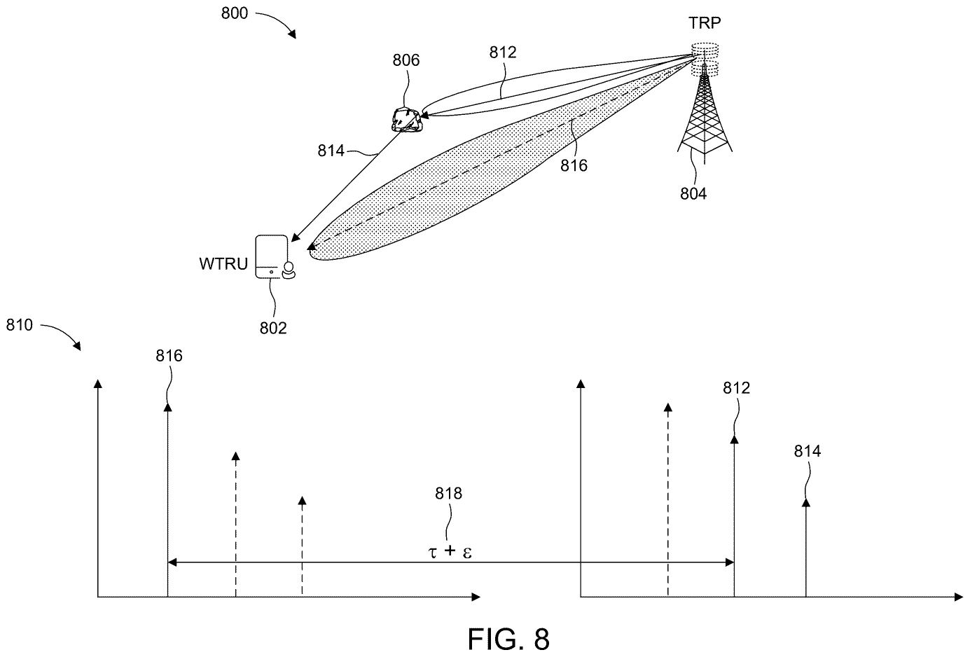

FIG. 8 is a diagram 800 illustrating an example of CIR behavior for sensing and positioning using separate RSs, according to one or more embodiments. As shown in FIG. 8, in some examples, the WTRU 802 is configured with an RS for sensing indicating time and frequency resources for the WTRU 802 to perform sensing measurements of a target object 806 in connection with TRP 804. For example, the WTRU 802 may be configured with another RS for positioning indicating time and frequency resources to perform positioning measurements. Further, for example, the WTRU 802 may perform positioning measurements on a LOS path (e.g., first path 816) and sensing measurements along a NLOS path (e.g., second path consisting of 812 and 814) may be measured with respect to the LOS path of the channel impulse response. As shown in graph 810, the WTRU 802 may determine an adjusted difference 818 between the channel impulse response of the first path 816 and the channel impulse response of the second path 812.

For example, the WTRU 802 may receive multiple RSs from one or multiple configured antenna ports for sensing (e.g., from different TRPs and/or a single TRP 804). Further, for example, the WTRU 802 may perform multiple configured measurements of the different channel responses obtained from the available TRPs and antenna ports for sensing and/or positioning. Additionally, for example, the WTRU 802 may perform relative measurements with respect to a first path 816 of the positioning channel impulse which may be directed towards the WTRU.

For example, the WTRU 802 may perform at least one of the following actions to achieve the aforementioned sensing and positioning measurements: obtaining the channel frequency responses at the configured RS resources (e.g., by removing the known values of the RS complex symbols and performing interpolation of the resulting responses over the desired frequency region); obtaining the corresponding time-domain CIR responses, e.g., by performing inverse frequency transformations on the obtained frequency responses (e.g., inverse discrete Fourier transforms); keeping the CIR or PDP peaks whose power or SNRs exceed the minimum configured RSRPP or SNR threshold (e.g., or whose peak correlation value between the received signal and the transmitted sensing signal is above a threshold) and discarding all others; keeping the CIR or PDP peaks received within a configured ToA or delay window and discarding all others; comparing the CIR or PDP responses against a configured CIR or PDP response expressed as a function of time; combinations of the same; or the like. Further, for example, the WTRU may obtain the PDP responses by computing the absolute square magnitude of the CIR responses. Additionally, for example, the WTRU may select the CIR peaks such that the difference between the probability density function (PDF) of the measured CIR or PDP response and one or more configured CIR or PDP responses are below a configured threshold.

In some examples, the WTRU is configured to perform relative measurements with respect to a predefined reference or expected value. For example, the reference point for the relative time measurements may be at least one of the following: the time instance of the WTRU request for sensing configuration; the time instance when the WTRU receives the network trigger to initiate sensing (e.g., via DCI/MAC-CE); transmit and receive time stamps; combinations of the same; or the like. Further, for example, the WTRU may measure the transmit and receive time stamps in terms of symbol index, slot index, frame index, or the like. Moreover, for example, the time stamps may be absolute, e.g., referring to the exact transmit and receive time of the RS resources (e.g., Tx time: 5th slot, Rx time 6th slot, Rx-Tx time difference=Rx timestamp−Tx timestamp=1 slot). Also, for example, the time stamps may be relative, e.g., referring to the difference in transmit and receive time of the RS resources (e.g., Rx-Tx time difference=1 slot). In some examples, the WTRU is configured to perform absolute measurements instead of relative measurements.

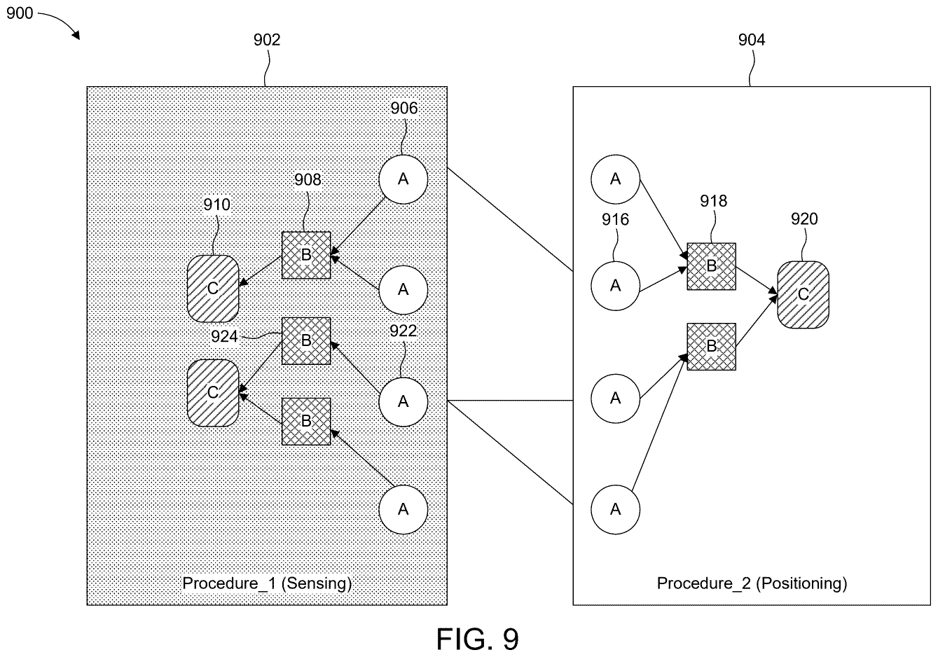

FIG. 9 is a diagram 900 of hierarchal measurement dependency within and between WTRU procedures, according to one or more embodiments. As shown in FIG. 9, in certain representative embodiments, the WTRU performs measurements based on a set of hierarchal measurements and dependencies (e.g., within or between procedures). For example, in procedure 1 902 (e.g., sensing) level A 906 corresponds to the set of measurements that are to be performed first (e.g., AoA, ToA, or the like). Further, for example, level B 908 may correspond to measurements that depend on some of the measurements performed at level A 906 (e.g., range estimation, velocity estimation, or the like). Similarly, level C 910 and higher-level measurements (e.g., RCS, MD, or the like) may depend on measurements performed at level B 908 and level A 906. Moreover, for example, a similar hierarchal structure may apply to procedure 2 904 (e.g., positioning), consisting of levels A 916, B 918, and C 920.

In some embodiments, the WTRU is configured with a set of structured rules between two different procedures (e.g., procedure 1 902 and procedure 2 904, sensing and positioning) that represents the hierarchal measurements and dependencies between the different measurements. For example, the structured rules may consider dependencies between sensing and positioning where the sensing AoA (e.g., level A 906 of procedure 1 902) measured from the target may depend on WTRU location that is a function of positioning AoA (e.g., level A 916 of procedure 2 904) measurements.

In some examples, the WTRU may start measuring the measurement set at a first level (e.g., level A 906 of procedure 1 902) with higher priority, and if the measurements are determined to be reliable, perform measurements at the second level (e.g., level B 908 of procedure 1 902). In other examples, the structured rules may be null (e.g., the rules do not indicate dependencies between measurements), and the measurements are treated as the baseline.

In one example, the WTRU is configured with trigger events as a function of hierarchal measurements and dependencies that may affect the reporting mode. For example, if a certain error pattern flow is determined to be in error (e.g., A1 906 to B1 908 to C1 910), the WTRU may perform a first set of actions (e.g., action_set1). Further, for example, in another error flow pattern (e.g., A2 922 to B2 924), the WTRU may perform another set of actions (e.g., action_set2).

In accordance with certain embodiments of the present disclosure, measurement error types and source determination procedures are described as follows.

In certain representative embodiments, the WTRU is configured by the WTRU to perform error source determination for each procedure. For example, the WTRU may be configured to determine the error type and error source based on sensing measurements. Further, for example, the WTRU may be configured to determine the error type and source based on positioning measurements.

For example, the WTRU may be configured by the network to determine the error source in the measurements. In one example, the WTRU determines an angle error source if an error is determined in angle measurements. In another example, the WTRU determines a time error source if an error is determined in time measurements.

For example, the WTRU may be configured to determine the error type of the measurements, based on at least one of a predefined set of measurements, sensing assistance information (e.g., hierarchal dependencies, reference values, thresholds, or the like), a time window (e.g., for sensing), combinations of the same, or the like. The WTRU may obtain at least one of the following metrics to determine the error type: the degree of proximity of sensing measurements with respect to a reference threshold (e.g., predefined threshold, mean of a predefined distribution, or the like); the degree of proximity of multiple measurements to each other (e.g., the spread of measurements); the degree of proximity of measurements under the same channel conditions; dependability of measurements over time and stability of measurements under predefined consistent conditions; signal quality (e.g., RSRP, RSRPP, or the like); combinations of the same; or the like. Further, for example, the WTRU may determine a higher distance of sensing measurements with respect to the reference threshold indicates a lower reliability and/or higher uncertainty. Additionally, for example, the WTRU may determine a higher degree spread of measurements indicates a lower reliability (e.g., or quality) of measurements and/or a higher uncertainty (e.g., and likelihood to have an error). Also, for example, the WTRU may determine that if repeated measurements over time under the same channel conditions are uniform (e.g., or identical), then the quality of measurements is high, the likelihood of the measurements having an error is low, and/or the reliability of the measurements is high. Furthermore, for example, the WTRU may determine that a higher dependability of the measurements over time indicates a higher quality of measurements that are less prone to errors.

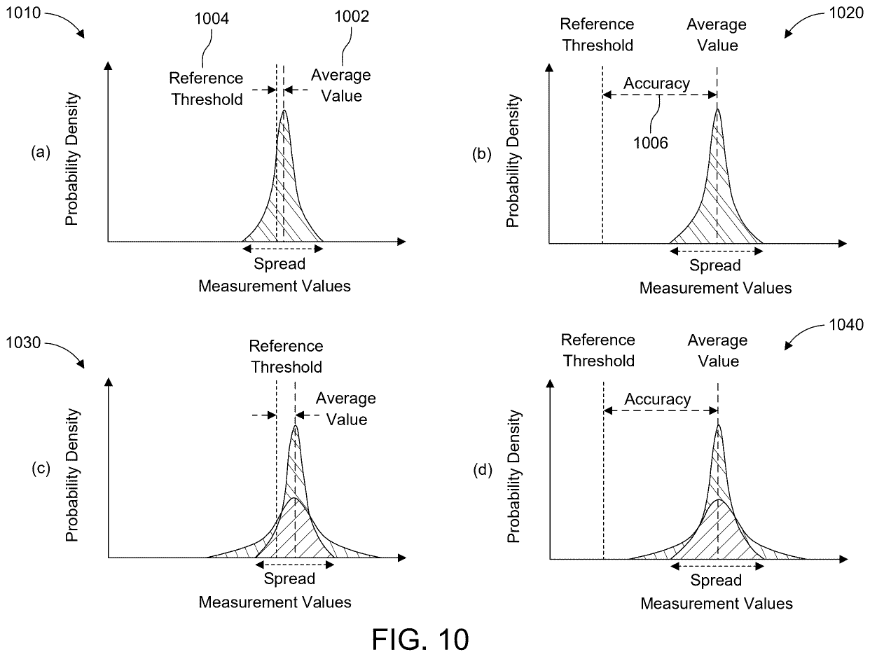

FIG. 10 is a diagram 1000 of error detection using a single measurement, according to one or more embodiments. As shown in FIG. 10, in some examples, the WTRU is configured by the network to determines errors per measurement in one or more of the sensing and/or positioning measurements, e.g., based on an average value 1002 and a reference threshold 1004. In an example scenario 1010, the WTRU determines no error based on the difference between the average value 1002 and the reference threshold 1004 (e.g., accuracy 1006) being below a predefined value and/or the spread 1008 of measurements being less than a defined threshold. In example scenario 1020, the WTRU determines a systematic error type (e.g., a positioning error) based on the difference between the average value 1002 and the reference threshold 1004 (e.g., accuracy 1006) being above a predefined threshold. In example scenario 1030, the WTRU determines a random measurement error type, e.g., based on the spread 1008, that may correspond to limited resources or bad channel conditions resulting in measurement error. In example scenario 1040, the WTRU determines a systematic and random measurement error type, e.g., based on the spread 1008 and the accuracy 1006, that may correspond to both a positioning error and limited resources or bad channel conditions.

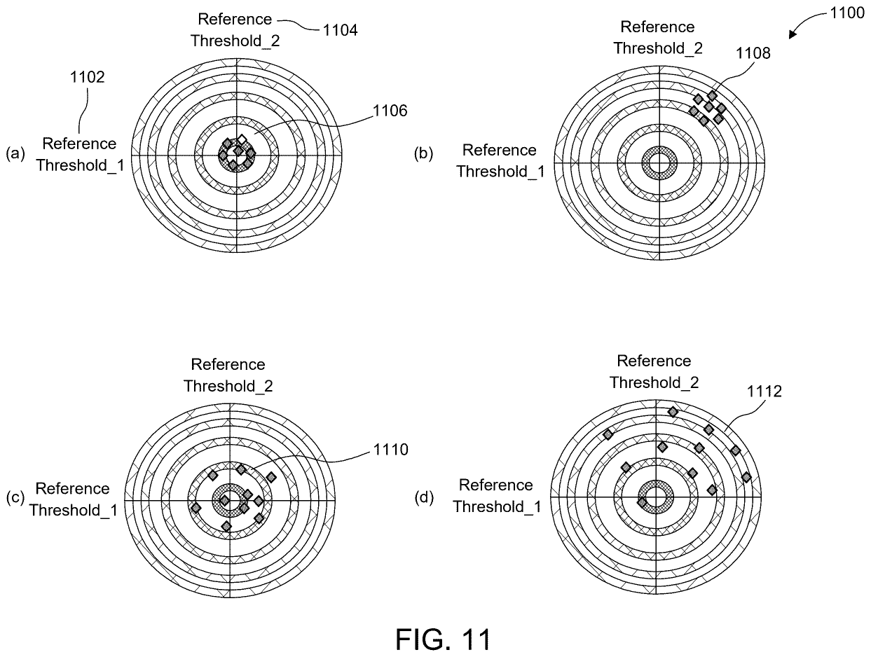

FIG. 11 is a diagram 1100 of joint error detection using multiple measurements, according to one or more embodiments. As shown in FIG. 11, the WTRU may be configured to perform joint error determination using two or more measurements of the same procedure (e.g., sensing measurements). For example, the WTRU may compare the measurements to a first reference threshold 1102 and a second reference threshold 1104. In one example, the WTRU determines measurements 1106 have no error based on the difference between average measurements over a defined period with respect to the corresponding reference thresholds being less than a defined threshold and/or the spread of all measurements over the defined period being less than a defined threshold. In another example, the WTRU determines that measurements 1108 correspond to a systematic measurement error type (e.g., positioning error), e.g., based on the distance of the average measurements from the corresponding reference thresholds. In another example, the WTRU determines that measurements 1110 correspond to a random measurement error type e.g., based on the spread of the measurements, which may indicate limited resources or bad channel conditions which results in measurement error. In another example, the WTRU determines that measurements 112 correspond to a systematic and random measurement error type, e.g., based on the distance of the average measurements from the corresponding reference thresholds and the spread of all measurements, which may relate to both positioning error and limited resources or bad channel conditions.

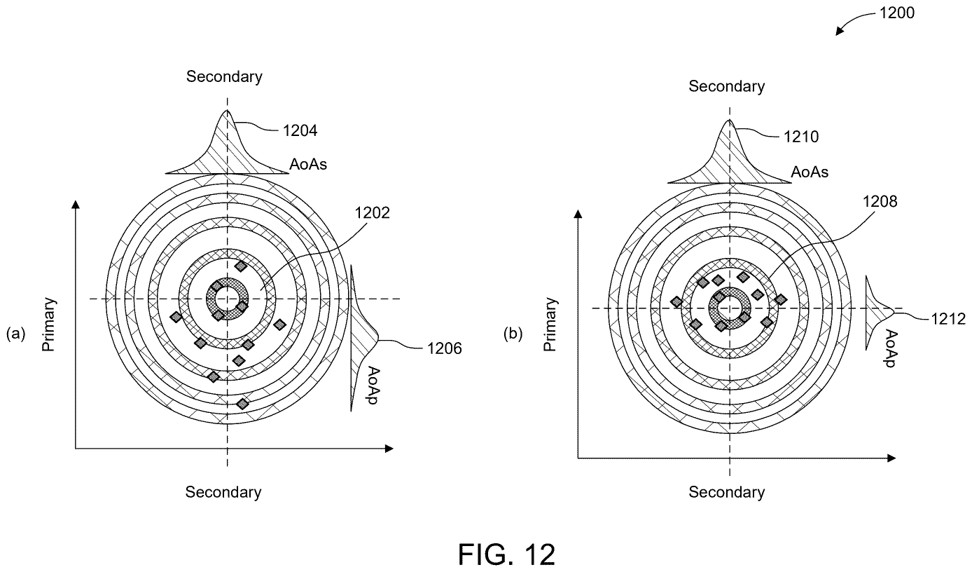

FIG. 12 is a diagram 1200 of error detection using hierarchal and dependency measurements, according to one or more embodiments. As shown in FIG. 12, in some embodiments, the WTRU is configured to perform joint error determination using two or more measurements mapping from different procedures (e.g., sensing and positioning measurements). For example, the WTRU may determine that measurements 1202 have low quality and/or reliability for sensing (e.g., AoAs 1204) based on the error in positioning measurements (e.g., AoAp 1206). Further, for example, the WTRU may determine that measurements 1208 have low quality or reliability for sensing (e.g., AoAs 1210) is not based on an error in positioning measurements (e.g., AoAp 1212) and thus the error has a different cause (e.g., channel conditions, limited resources, or the like). In some examples, the WTRU may select similar a type of measurements (e.g., AoA for sensing and AoA for positioning) for sensing and positioning joint error determination. In other examples, the WTRU may select different types of measurements (e.g., AoA for positioning and RCS for sensing) for sensing and positioning joint error determination. Additionally, for example, the WTRU may select the joint parameters according to preconfigured hierarchal measurements and dependencies within or across procedures.

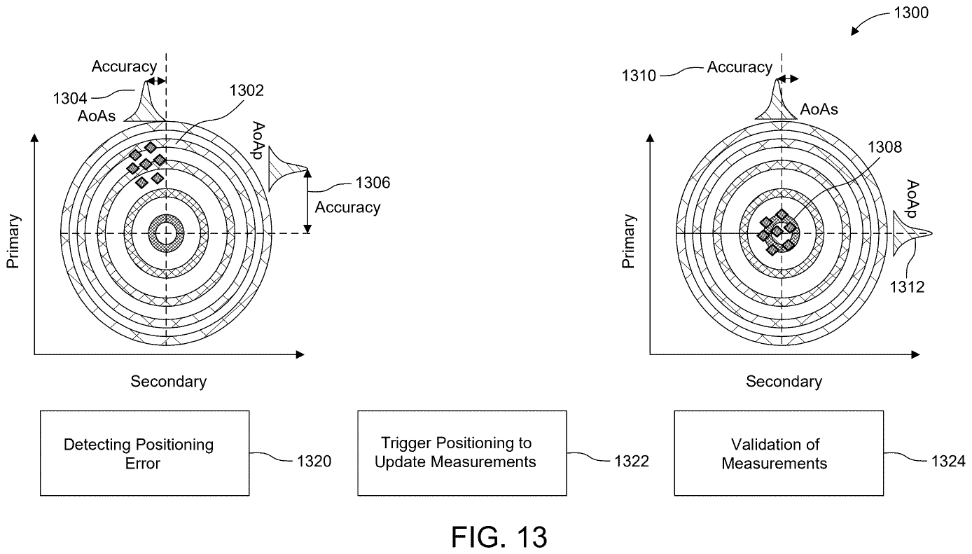

FIG. 13 is a diagram 1300 of an example measurement validation process, according to one or more embodiments. As shown in FIG. 13, in some embodiments, the WTRU is configured to perform joint error source determination to validate the updated measurements (e.g., after triggering the corresponding event). For example, the WTRU detects 1320 a positioning error of measurements 1302 based on determining a high distance between the average positioning measurement 1306 and/or average sensing measurement 1304 with respect to the relevant reference threshold and/or the spread of all measurements is high. Further, for example, the WTRU triggers 1322 positioning to update measurements and validates 1324 the updated measurements 1308. Additionally, for example, the WTRU validates updated measurements 1308 based on determining that the distance between the average positioning measurement 1312 and/or the average sensing measurement 1310 with respect to the relevant reference threshold is low and/or the spread of all measurements is low.

In some examples, the WTRU performs joint error determination to investigate the performance update as a function of the actions considered. For example, action 1 improved the updated measurements by decreasing the error and/or increasing quality of measurements. Further, for example, action 2 degraded the updated measurements by increasing error and/or decreasing quality of measurements.

In some embodiments, the WTRU is configured by the network to indicate the error propagation nature from one measurement to another.

In one example, the WTRU may determine over a defined period if the error is increasing or decreasing linearly. For example, the error may be isolated and maintained by tuning the configuration. Moreover, for example, a longer validity window (e.g., for positioning measurements) may be considered after addressing the error. In another example, the WTRU may determine over a defined period if the error is changing non-linearly. For example, if the error is changing non-linearly, the configuration is changed. Additionally, for example, a short validity window (e.g., for positioning measurements) may be considered even after addressing the error.

In accordance with certain embodiments of the present disclosure, events triggering positioning are described as follows.

In certain representative embodiments, the WTRU determines to perform positioning based on periodically monitoring for events that trigger positioning, e.g., after receiving the RS configurations and the positioning time window configurations (e.g., included in the sensing assistance information). For example, the WTRU may determine to perform positioning after detecting a change in one or more sensing measurement accuracies as a result of at least one of the following: receiving multiple re-sensing requests; observing a change (e.g., decrease, increase) in the measured RSRP values of the sensing RS signal below or above a configured threshold; observing a change in one or more of the sensing measurements over or below a configured threshold between two measurement occasions or over a defined period; observing change in the channel environment (e.g., increase or decrease in number of multipath components); observing change in the relative sensing measurements with respect to LOS path below or above a configured threshold; combinations of the same; or the like.

In some examples, the WTRU triggers positioning after detecting a change in an RS metric, signal parameter, and/or or other measurements as a result of at least one of the following: experiencing a change in the SNR or SINR in the communication channel above a configured threshold and/or receiving the RS (e.g., CSI-RS, SSB, DM-RS, or the like) with a drop in RSRP above a configured threshold.

In some examples, the WTRU triggers positioning based on the determined error type detected based on sensing measurements and sensing assistance information, as a result of at least one of the following: observing a difference between the mean value in the sensing measurements is above a configured threshold and the variance is below a certain threshold (e.g., systematic error); observing difference between the mean value in the sensing measurements is below a threshold and the variance is above a configured threshold (e.g., random error); observing that the value of one or more measurements over time are not stable, independent, and/or consistent (e.g., change in measurement statistics, samples do not follow a configured distribution); observing that under the same channel conditions the spread of the sensing measurements over a defined period exceed a configured threshold; experiencing changes in channel conditions; combinations of the same; or the like. For example, the WTRU may trigger a configured positioning method based on determining systematic error. Further, for example, the WTRU may initiate, suggest, and/or recommend a positioning method with particular positioning parameters (e.g., via on-demand PRS request) based on determining random error.

In some embodiments, the WTRU triggers specific RAT-based positioning methods based on determined error type and error source. For example, if the determined error source is angle-based, the WTRU triggers and/or indicates to the network to configure the time-based positioning method (e.g., multi-round-trip time (RTT)). Further, for example, if the determined error source is time-based, the WTRU triggers and/or indicates to the network to configure the angle-based positioning method (e.g., DL-AoD).

In some embodiments, the WTRU triggers positioning when the positioning information (e.g., included in the sensing assistance information) is outdated or no longer valid. For example, the positioning time window may be expired. Further, for example, the WTRU receives new or updated sensing assistance information and/or new or updated RS configuration, e.g., without new or updated positioning information. Also, for example, the WTRU may determine the event trigger based on at least one of the following: the configured positioning value exceeded the valid time window T1, a new or updated error source distribution for positioning and/or sensing is configured by the network, a new type of error sources is configured, combinations of the same, or the like.

In some embodiments, the WTRU receives an implicit indicator from the network to initiate positioning, e.g., by dynamic signaling via MAC-CE, DCI, or the like. For example, this indication may be triggered by the network to achieve at least one of the following: to validate the sensing measurements using positioning measurements; to apply environmental reconstruction; to apply heatmap measurements; to compare results collected from multiple WTRUs that fall within a certain geographical location; combinations of the same; or the like.

For example, the WTRU may trigger non-RAT based positioning method and/or RAT-based positioning methods when the latter does not satisfy positioning requirements on its own.

For example, the WTRU may trigger positioning when a certain target and/or WTRU mobility measurement is above or below a predefined threshold and/or within a range of threshold values. Further, for example, the WTRU may trigger positioning if the difference between the measured WTRU velocity and the measured target velocity is below a predefined threshold and/or within a certain range of threshold values.

For example, the WTRU may trigger positioning when WTRU enters and/or leaves certain geographical areas. Also, for example, the WTRU may trigger positioning when a handover is detected and/or when any cell switching related measurement is below or above a defined threshold.

In some examples, the WTRU triggers one or more positioning-related actions (e.g., joint positioning) when sensing QoS requirements require greater positioning accuracy to be achieved. Events that may trigger this behavior include at least one of the following: when QoS of sensing requirements drops below a predefined threshold; when QoS of sensing task requirements cannot be achieved using coarse WTRU location and better positioning is required; when one or more of the sensing measurements accuracies falls below a certain threshold, or uncertainty falls above a certain threshold; combinations of the same; or the like.

In some embodiments, the WTRU is a PRU. For example, the WTRU may receive a request from the network (e.g., LMF, gNB, or the like) to report measurements related to positioning. Further, for example, the WTRU may receive a request to report positioning measurements and sensing measurements to the network. Moreover, for example, the WTRU may receive a request from the network to report measurements and WTRU location (e.g., determined based on a RAT-dependent or a RAT-independent positioning method).

In some examples, the WTRU may receive a request to associate measurements for positioning and measurements for sensing. For example, if the WTRU reports RSTD for positioning measurements, the WTRU may determine to associate RSTD reported for positioning with RSTD reported for sensing. Further, for example, the WTRU may determine RSTD based on two TRPs or two PRS resources. Additionally, for example, the WTRU may report DL-RS configurations (e.g., PRS ID, PRS resource ID, TRP ID, or the like) used to determine RSTDs for positioning and/or sensing. Moreover, for example, the WTRU may determine to associate positioning measurements and sensing measurements to indicate that the common measurement can be used for sensing (e.g., determining location of the target) or positioning purpose (e.g., determining WTRU location).

In some embodiments, the WTRU receives, from the network, more than one set of DL-RS configurations. For example, the WTRU may determine the first set of DL-RS configuration to be for sensing. Further, for example, if the WTRU determines to perform positioning, the WTRU may determine to use the second set of DL-RS configurations for positioning. Also, for example, in the configuration the WTRU receives from the network, the usage of the first and second set may be associated with sensing and positioning, respectively. Additionally, for example, the first and second set of configurations may be associated with each other. Furthermore, for example, if the WTRU determines to use the first set of DL-RS configuration for sensing, the WTRU determines to use the second set of DL-RS configurations for positioning which is associated with the first set. In one example, the WTRU determines the first and/or second set of DL-RS configurations. In such an example, the WTRU may report the first and/or second set of DL-RS configurations to the network along with the associated measurements.

For example, the WTRU may determine to perform positioning if the WTRU detects more than one paths in the sensing measurement (e.g., RSTD, PDP, CIR, DP, or the like).

In some embodiments, the WTRU determines to perform positioning if the WTRU receives a request to report a reference location with respect to which the target location is defined. For example, the WTRU may receive a request from the network to determine and report relative location of the target with respect to a reference. Further, for example, the WTRU may be configured with a choice of reference locations (e.g., PRU, TRP, WTRU location). Additionally, for example, the WTRU may receive information (e.g., via broadcast) of locations of references (e.g., PRU locations, TRP locations, or the like). Additionally, for example, the WTRU may determine to report the WTRU location if the WTRU is not provided with a list of reference locations. Moreover, for example, the WTRU may receive an indication from the network including which positioning method to use to determine its location (e.g., via RAT-dependent positioning method such as DL-TDoA, RAT-independent positioning method such as global navigation satellite system (GNSS) positioning). Furthermore, for example, the WTRU may indicate to the network the positioning method used to determine the WTRU location. Also, for example, the WTRU may send a request to the network for assistance data for positioning (e.g., PRS configurations).

In certain representative embodiments, WTRU actions are provided as a function of positioning conditions. In one solution, the WTRU process to monitor and/or determine whether or not sensing measurements are reliable based on at least one of the following conditions: a degree of proximity of one or more of the sensing measurements with respect to a reference threshold, a degree of proximity of multiple measurements to each other or determine spread of measurements, a degree of proximity of the measurements under same channel conditions, a dependability of measurements over time and the stability of the measurements under predefined consistent conditions, a signal quality (e.g., RSRP, RSRPP), preconfigured and/or configured sensing requirements, combinations of the same, or the like.

For example, regarding the degree of proximity of one or more of the sensing measurements with respect to the reference threshold (e.g., predefined threshold, mean of a predefined distribution, or the like), the reference value for AoA is 30 degrees, with a threshold of 2 degrees. Therefore, for example, the average AoA measurements fall within the range of 28 to 32 degrees to be considered reliable. Any measurements outside this range will be deemed unreliable.

Also, for example, regarding the degree of proximity of multiple measurements to each other or determine spread of measurements, the reference value for AoA variance is 4 degrees. Therefore, if the variance of the samples is below this threshold, it will be considered reliable. Otherwise, it will be deemed unreliable.

Further, for example, regarding the degree of proximity of the measurements under same channel conditions, if the channel conditions are stable with only slight variations over time, the measurements will be consistent. This uniformity in repeated measurements indicates high-quality data, low likelihood of errors, and high reliability.

In addition, for example, regarding the dependability of measurements over time and the stability of the measurements under predefined consistent conditions, the more dependable the measurements are over time, the higher their quality and the less prone they are to errors.

In one example, the WTRU may determine one or more sensing measurements are unreliable. Also, for example, based on the WTRU determining one or more sensing measurements are unreliable, at least one of the following actions are performed: WTRU sends Uplink-Assistance Information to the network, e.g., indicate error type (e.g., positioning not reliable), and/or error source, and/or cause of the error, and/or actions performed, or the like; the WTRU may be configured to log “erroneous” sensing measurements mechanics; the WTRU may change what is reported in the measurement reports; the WTRU may decrease the granularity of measurements; the WTRU may use a longer discontinuous reception (DRX) cycle for sensing; combinations of the same; or the like.

For example, regarding the WTRU configured to log “erroneous” sensing measurements mechanics, the WTRU may define start and/or stop time of logging window. Also, for example, the start and/or stop time of logging window may be defined in accordance with at least one of: in terms of symbol index, slot index, frame index, absolute time, relative time with respect to a reference point, or the like); the logging window duration may depend on the configured sensing task; the logging window duration may be configured by the NW; combinations of the same; or the like. Further, for example, regarding the WTRU configured to log “erroneous” sensing measurements mechanics, the WTRU may indicate what is logged (e.g., measurements, error type, error source, or the like). In addition, for example, the WTRU may indicate what actions are considered when logging is too long (e.g., multiple logging files, decrease the periodicity of measurements, or the like). Moreover, for example, the WTRU may indicate what actions are considered when logging stops (e.g., all measurements sent, flush buffer, or the like).

Also, for example, regarding the WTRU changing what is reported in the measurement reports, the WTRU may trigger some reports as a function of unreliable measurement conditions; and/or stop triggering some of reports (e.g., if measurements are not useful).

In one example, the WTRU may determine one or more sensing measurements are unreliable due to positioning error. Also, for example, based on the WTRU determining one or more sensing measurements are unreliable due to positioning error, the WTRU will apply a set of actions to improve sensing by improving positioning. The WTRU may apply at least one of the following actions: suggests and/or indicates to the network better positioning method based on determined error type and error source (e.g., if determined error source is angle based the WTRU may indicate to perform time-based positioning method); performs joint positioning method to improve positioning accuracy (e.g., WTRU applies joint positioning method (e.g., DL TDOA and DL AoD/UL AoA)); WTRU activates over existing positioning method carrier phased positioning (CPP) enhancement; WTRU autonomously applies non-RAT positioning (e.g., using GPS); WTRU applies fusion of RAT based and non-RAT based positioning measurements; search for different supporting and/or neighbor cell to perform positioning measurements; collects more measurements by increasing the positioning window; requests updated positioning assisted information; prioritize positioning over sensing procedure (e.g., pause sensing or log sensing measurements, improve positioning to satisfy requirements then resume sensing); the WTRU may add MeasID list (e.g., association between reporting config list and measurement object lists (sensing and/or positioning)); combinations of the same; or the like.

Also, for example, regarding the WTRU activating over existing positioning method CPP enhancement, if time-based error is detected, CPP might require at least one positioning reference unit (PRU) to cancel out WTRU clock offset and mitigate oscillator drift and initial phase error. Further, for example, if angle-based error is detected, the WTRU activates CPP enhancement to increase angular resolution.

In one example, the WTRU may determine one or more sensing measurements are unreliable due to random error (e.g., configuration error). For example, based on the WTRU determining one or more sensing measurements are unreliable due to random error, the WTRU will apply at least one of the following actions: WTRU may request and/or suggest new sensing configuration based on determined error source; WTRU may apply autonomously a different sensing configuration (e.g., base configuration); WTRU may activate and/or apply a new configuration for a second type (e.g., of dependent) measurement-positioning assisted sensing (e.g., configuration could be associated to the characteristics of the problem, to identify error type and/or error source of problem); WTRU may apply different sensing measurements granularity; WTRU may apply different measurement quantity or methods; WTRU may pause sensing for a predefined and/or defined time window that depends on the sensing task; combinations of the same; or the like.

Also, for example, regarding the WTRU requesting and/or suggesting new sensing configuration based on determined error source, the WTRU requests one or more positioning configurations to address various error sources including at least one of: high bandwidth, lower comb structure, more PRBs for time errors; high angular resolution for angle errors; low repetition factor for doppler errors; lower comb structure for power errors; combinations of the same; or the like. Further, for example, based on time error sources detected (e.g., ToA, RSTDs), the WTRU requests positioning configuration with high BW, and/or lower comb structure and/or high number of PRBs. In addition, for example, based on angle error sources detected (e.g., AoA, AoD), the WTRU requests positioning configuration that features high angular resolution. Moreover, for example, based on doppler error sources detected (e.g., DL RSCP), the WTRU requests positioning configuration with low repetition factor to cope with larger delay spread range. Furthermore, for example, based on power error sources detected (e.g., RSRP), the WTRU requests lower comb structure to cope with high noise level.

In one example, the WTRU may determine one or more sensing measurements are unreliable due to combination of positioning and non-positioning error (e.g., configuration error). For example, based on the WTRU determining one or more sensing measurements are unreliable due to combination of positioning and non-positioning error, at least one of the following actions are applied: WTRU may send all measurements; WTRU may pause sensing and positioning over a predefined and/or defined time window; WTRU may terminate sensing and positioning procedures; combinations of the same; or the like.

In another example, the WTRU may determine one or more sensing measurements are reliable. For example, based on the WTRU determining one or more sensing measurements are reliable, at least one of the following actions are applied: WTRU may perform sensing procedure as normal including measurements, reporting, or the like; WTRU may increase reporting period; WTRU may decrease measurements and reporting; WTRU may perform subset of sensing measurements related to the sensing task; WTRU may extend the positioning validity window; WTRU may send the positioning validity window to the NW (e.g., LMF, SF, gNB); combinations of the same; or the like.

In another example, the WTRU may fail to determine if sensing measurements are reliable or not. For example, the WTRU may fail to determine if sensing measurements are reliable or not based on at least one of the following: sensing requirements are not satisfied; no error type is determined; no error source is determined; multiple resensing requests exist over a preconfigured number; the WTRU may activate and/or apply a new configuration for a second type (e.g., of dependent) measurement-positioning assisted sensing (e.g., configuration could be associated to the characteristics of the problem, to identify error type and/or error source of problem); the WTRU may terminate sensing procedure; the WTRU may request for reconfiguration for sensing and positioning; the WTRU may pause sensing and positioning for a predefined period; the WTRU may remove MeasID list (e.g., association between reporting config list and measurement object lists (e.g., sensing and/or positioning)); the WTRU may report all measurements and terminate; combinations of the same; or the like.

In one example, the WTRU may trigger a set of actions as a function of the determined sensing triggering positioning event. For example, the WTRU triggers a set of actions as a function of the determined sensing triggering positioning event, based on at least one of the following: location-based triggers, QoS-based triggers, mobility-based triggers, time-based triggers, event-based triggers, determined error type, determined error source, hierarchical measurements triggers, combinations of the same, or the like.

For example, the location-based triggers may correspond to when the WTRU enters and/or leaves a certain geographical area, or when it detects proximity to a particular target or location. In one example, the WTRU may be triggered to initiate or terminate a target sensing task if a difference between the measured WTRU location (e.g., using RAT-dependent and/or non-RAT based methods) and the configured target location are below a certain threshold.

Also, for example, the QoS-based triggers may be based on sensing estimation accuracy. The WTRU may initiate a positioning procedure to improve the sensing accuracy by improving positioning.

Further, for example, the mobility-based triggers include accounting for the WTRU being stationary or mobile. In one example, the WTRU may be triggered to activate or deactivate a positioning procedure if the measured WTRU velocity is above a threshold value and/or within a range of threshold values.

In addition, for example, the time-based triggers include the WTRU initiating or terminating a positioning measurements update at predefined intervals for periodic update.

Moreover, for example, the event-based triggers include the WTRU initiating or terminating positioning procedure when certain signal parameters (e.g., peak to side lobe, SINR, RSRP, interference level, or the like) are above or below one or more preconfigured and/or configured thresholds.

Furthermore, for example, the determined error type may be based on the determined error type (e.g., systematic or random error type). In one example, the WTRU may initiate or terminate positioning if a systematic error is detected. In another example, the WTRU may request a configuration modification (e.g., using on-demand PRS request) if the determined error type is random.

Additionally, for example, the determined error source may be based on the determined error source (e.g., angle-based or time-based), or the like. In one example, if a time-based error source is determined, the WTRU may terminate a time-based positioning method and initiate an angle-based positioning method.

Still further, for example, the hierarchical measurements triggers may be based on detected error flow in sensing measurements and/or a dependency pattern between WTRU, which may trigger positioning to reduce the error propagation effect.

In one solution, the WTRU may determine the validity window of the positioning information, and send one or more updated values to the network (e.g., LMF). For example, the WTRU determines the validity window of the positioning information, and sends one or more updated values to the network based on at least one of the following: the determined error type, the determined error source, sensing measurement's integrity (e.g., accuracy, precision, consistency, reliability, or the like), previous sensing time window, previous positioning validity window, age of information for sensing and positioning, measurements of signal metrics (e.g., RSRP, RSRPP, peak to side lobe, interference level, or the like), combinations of the same, or the like.

In one solution, the WTRU may validate sensing measurements by triggering positioning and performing joint error determination using sensing and positioning measurements.

In one solution, the WTRU may switch sensing modes from bistatic to monostatic to validate the errors, by computing the target location (e.g., in monostatic) and comparing it to the location achieved in bistatic.

In certain representative embodiments, WTRU reporting is provided. For example, the WTRU reporting includes at least one of WTRU reporting, one or more WTRU reporting updates, WTRU reporting termination, combinations of the same, or the like.

In one example, the WTRU performs sensing assisted positioning measurements and reports and/or sends and/or recommends to NW (e.g., gNB and/or LMF and/or sensing entity) a sensing assisted positioning report in periodic, aperiodic or semi-persistent from over an uplink control or data channel.

In one example, the WTRU may determine the report mode based on at least one of the following: reporting configuration, triggered event, determined error type, determined error source, NW entity that initiated the procedure, other defined parameters, combinations of the same, or the like.

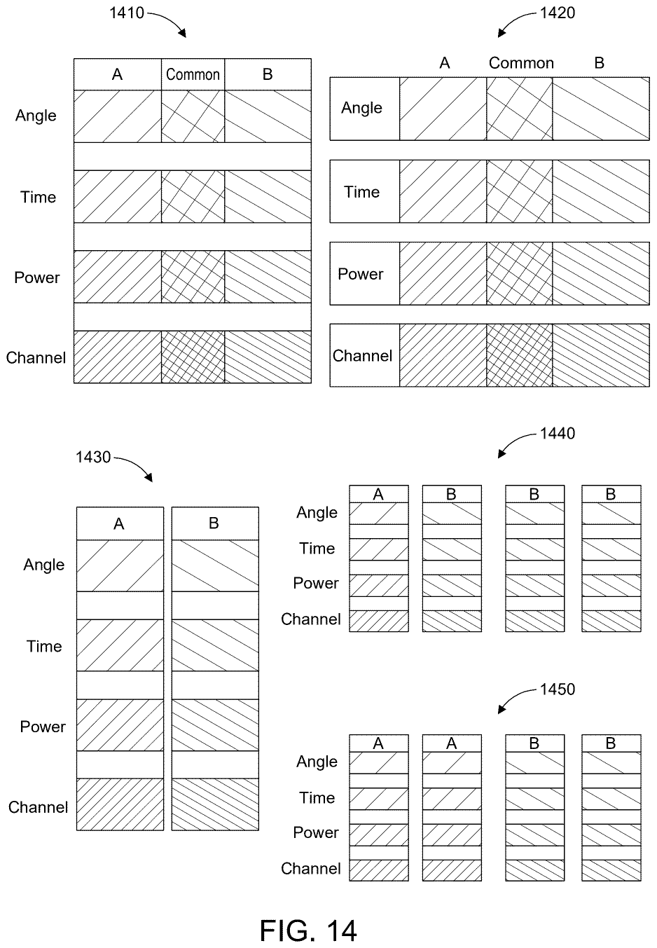

In one example, the WTRU may determine the event of sensing assisted positioning based on measurement type (e.g., FIG. 14). The WTRU sends the sensing assisted positioning report to the NW that may contain at least one of the following: time measurements (e.g., sensing time measurements, positioning time measurements, common time measurements used for sensing and positioning, or the like); angle measurements (e.g., sensing angle measurements, positioning angle measurements, common angle measurements used for sensing and positioning, or the like); channel measurements (e.g., sensing channel measurements, positioning channel measurements, common channel measurements used for sensing and positioning, or the like); phase measurements (e.g., sensing phase measurements, positioning phase measurements, common phase measurements used for sensing and positioning, or the like); power measurements (e.g., sensing power measurements, positioning power measurements, common power measurements used for sensing and positioning, or the like); combinations of the same; or the like. Although phase measurements are not explicitly shown in FIG. 14, in some implementations, it is understood one or more phase measurements may be combined with any one of the one or more angle, time, power, and/or channel measurements in any suitable combination.

For example, in a first (e.g., sensing and/or positioning) reporting mode 1410, each of angle, time, power, and channel are measured using procedure A and using procedure B. Also, for example, common measurements of each of angle, time, power, and channel are performed.

For example, in a second (e.g., sensing and/or positioning) reporting mode 1420, each of angle, time, power, and channel are separately measured using procedure A and using procedure B. Also, for example, a common measurement for each of angle, time, power, and channel is separately performed.

For example, in a third (e.g., sensing and/or positioning) reporting mode 1430, each of angle, time, power, and channel are measured using procedure A. Also, for example, separately, each of angle, time, power, and channel are measured using procedure B. Further, for example, the reports of procedure A and procedure B are associated with each other.

For example, in a fourth (e.g., sensing and/or positioning) reporting mode 1440, a first report of procedure A is associated with first, second, and third reports of procedure B.

For example, in a fifth (e.g., sensing and/or positioning) reporting mode 1450, a first report of procedure A is associated with a second report of procedure A, a first report of procedure B, and a second report of procedure B.

In one example, the WTRU may trigger to report and/or indicate and/or include in the sensing assisted positioning report at least one of the following: sensing measurements associated with target object with uncertainties; positioning measurements with uncertainties; information not related to target object (e.g., total number of NLOS groups, average RSRP, or the like); the determined error type relevant to the performed measurements (e.g., systematic, random); the determined error source (e.g., angle error source, time error source, or the like); the error dependency type between hierarchal measurements (e.g., linear, non-linear); the WTRU and/or TRP timing error (e.g., WTRU reaction time to detect start and stop conditions of a timer, or the like); the measurement method used (e.g., absolute and/or relative); the activated and/or deactivated procedures performed (e.g., RAT, non-RAT positioning methods); measurement search window (e.g., length of the window, type, method used to calculate, start time of the window, or the like); the set of WTRU actions performed; combinations of the same; or the like.

In one example, the WTRU may report and/or suggest and/or recommend to the NW as a function of the determined triggering event at least one of the following: reconfiguration for sensing (e.g., if time-based error source is determined and random error type the WTRU requests and/or suggests and/or recommend increasing the BW); reconfiguration for positioning (e.g., if angle error source is determined the WTRU requests and/or suggests and/or recommend time-based positioning method); indicate termination of the procedure; indicate integrity failure or success; pause for sensing and/or positioning procedures and identify related information (e.g., defined time window, DRX cycle used, switch to RRC inactive state); stop reporting of sensing and/or positioning reports; change in report periodicity; combinations of the same; or the like.

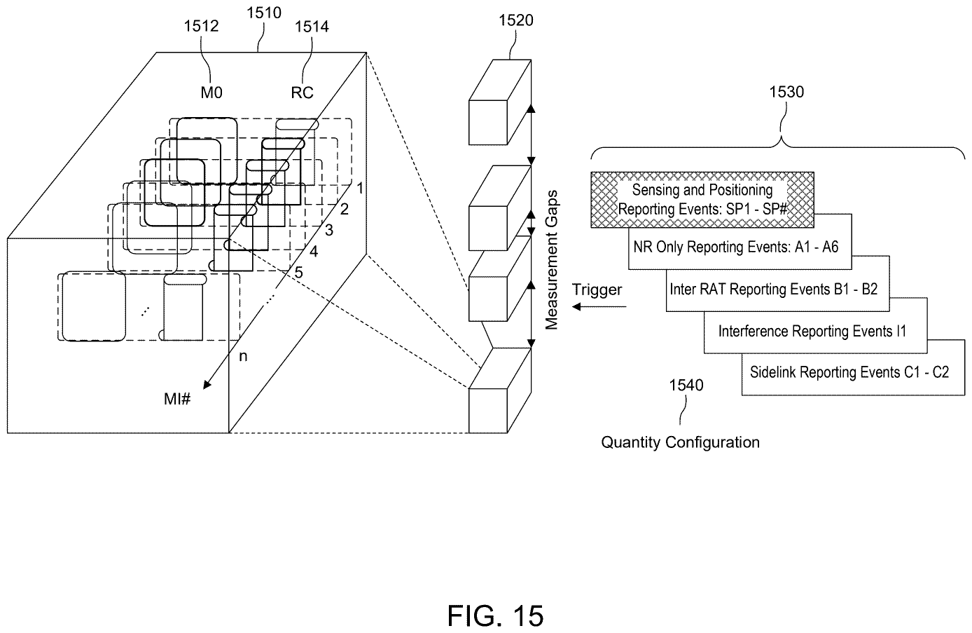

In one example, the WTRU may report an association between sensing and positioning information at different granularity levels. For example, the WTRU reports an association between sensing and positioning information at different granularity levels, and does so retro-actively according to certain triggering conditions. Also, for example, examples of the triggering conditions are shown in FIG. 15. Further, for example, sensing and positioning reporting comprises at least one of the following: reportConfig (RC), which contains reporting configuration list for sensing and/or positioning report IDs; measObject, which contains measurement object (MO) list for sensing and/or positioning MO IDs; measID list (e.g., one-to-one mapping between reportConfig list and measObject list); the WTRU may associate between one or more sensing report with one or more positioning report; the WTRU may associate one or more sensing measurement objects with one or more positioning measurement objects; the WTRU may associate the measurement objects (e.g., sensing and/or positioning) with one or more reporting configurations (e.g., sensing and/or positioning); the WTRU may associate measurement ID to one-to-one mapping between reporting configuration and measurement object lists; the WTRU may associate at least one of measurement IDs to a sensing task; combinations of the same; or the like.

For example, as shown in FIG. 15, a report 1510 includes, for each of any number of a measurement index (MI #) from 1 to n, an MO list 1512, and an RC list 1514. Also, for example, each report (e.g., 1510) of a plurality of reports may be separated from another report by various measurement time gaps 1520. As shown in FIG. 15, the measurement time gaps may not be uniform between reports. Further, for example, a report (e.g., 1510) is triggered by one or more events 1530. In addition, for example, the one or more events 1530 include at least one of: sensing and/or positioning reporting events (e.g., SP1 to SP #), NR only reporting events (e.g., A1 to A6), inter RAT reporting events (e.g., B1 to B2), interference reporting events (e.g., I1), sidelink reporting events (e.g., C1 to C2), combinations of the same, or the like. Moreover, for example, each of the one or more events may include the measurement time gaps 1520 and/or a quantity configuration 1540, e.g., a number of reports to be generated. Furthermore, for example, regarding the one or more events 1530, for the sensing and/or positioning reporting events SP1 to SP #, new triggers are defined by new events and/or conditions that initiate sensing and/or positioning. The new triggers require the measurement gaps 1520, which may be configured periodically or aperiodically, among other options. Additionally, for example, each measurement gap 1520 includes an MO list 1512 and an RC list 1514. Still further, for example, one or more RC elements are mapped to one or more MO elements. Even further, for example, each mapping between RCs and MOs has an index in the MI list within the report 1510 (e.g., MO1 and RC1 at MI2, MO2 and RC2 at MI2 . . . . MO(n) and RC(n) at MI(n)).

In one example, the WTRU may report to the NW logging of errors for sensing and/or positioning mechanics. For example, the WTRU reports to the NW the logging of errors for sensing and/or positioning mechanics including at least one of the following: logging erroneous conditions (e.g., based on positioning and/or sensing conditions); logging erroneous duration (e.g., a logging time window or logging report number); logging erroneous actions performed (e.g., WTRU performs low periodicity for measurements, stops association between sensing and positioning measurements and/or information, or the like); logging erroneous resume actions performed (e.g., WTRU performs high periodicity for measurements, resume association between sensing and positioning, or the like); combinations of the same; or the like.

In one example, the WTRU sends the related measurements and reports to the relevant entity based on a reference signal configuration. In one example, the WTRU may send positioning measurements in addition to common measurements to the relevant positioning entity (e.g., LMF) mainly responsible for positioning. In one example, the WTRU may send sensing measurements in addition to common measurements to sensing entity (e.g., sensing entity, gNB, LMF) mainly responsible for sensing. In one example, the WTRU may send all measurements (e.g., sensing and positioning) to the sensing entity and/or positioning entity. In another example, the WTRU may send the report to the entity that initiated the procedure.

In one example, the WTRU may send the sensing assisted positioning measurement report over any configured uplink control or data channel. In another example, the WTRU may be configured to send each report mode on preconfigured uplink control or data channel based on the report type and/or triggering event type (e.g., report mode 1 sent over PUSCH, while report mode 2 over PUCCH).

In one solution, the measurement report may be transmitted through PUSCH, e.g., via RRC and/or MAC-CE through a configured scheduling mechanism (e.g., configured grant).

In one example, the WTRU may be configured to send decoding information (e.g., report format, type of content, allocated fields for each measurement, or the like) for the sensing assisted positioning measurement report on specific uplink control or data channel (e.g., the WTRU may send the decoding information of the report associated with sensing and positioning combination on the PUCCH). In another example, the gNB may blind-decode the received measurement sensing report from the WTRU. In one example, the WTRU may be configured to send its report to the network on a specific uplink control or data channel based on the measurement time granularity.

In another example, the WTRU may be configured to send its report to the network on a specific uplink control or data channel based on the report periodicity type (e.g., periodic, aperiodic, semi-persistent, or the like).

In one example, the WTRU may determine the event of sensing assisted positioning procedure and report to the network in a periodic, aperiodic or semi-persistent form. In one example, the WTRU may be configured with specific reporting periodicity that is associated to the determined event (e.g., event trigger, error type, error source, or the like). In another example, the WTRU may be configured with reporting periodicity that is associated to the likelihood of positioning error. In another example, the WTRU may be configured with a specific reporting periodicity that is associated to the reliability of sensing and/or positioning measurements.

In another example, the WTRU may also be configured to report in addition to sensing measurements its positioning using RAT independent methods if capable such as by using the GPS. The WTRU may report its position upon detecting at least one of positioning triggers.

In some embodiments, WTRU reporting updates are provided. In one example, the WTRU may perform measurements on the RS reflected from the target location and/or WTRU location over multiple measurement occasions (e.g., multi-slot level, e.g., repetition factor, time gap configurations). The WTRU may determine that the target sensing task measurement report and/or WTRU positioning information may be invalid or outdated. For example, the WTRU may determine that the target sensing task measurement report and/or WTRU positioning information may be invalid or outdated based on at least one of the following: the change of WTRU location (e.g., moving outside a preconfigured geographical location, that may be changing in positioning measurements either from serving TRP or neighbor TRPs reflected change of one or more positioning-related measurements above or below a predefined threshold); the change of target location (e.g., target location outside a preconfigured sensing area, that may be changing in target sensing measurements reflected change of one or more positioning-related measurements above or below a predefined threshold); the change of environment (e.g., captured by change in CIR, PDP, DP, or the like); the change of error type determined; the change of error source determined; the change of triggering event conditions; the change of error measurement flow between dependent measurements; the change in the measured RS metric(s) and/or KPI(s) over a preconfigured threshold; receiving update request by other entity (e.g., gNB, LMF, SF); combinations of the same; or the like.

For example, based on any of the above, the WTRU may perform new sensing assisted positioning measurements. Also, for example, the WTRU determines to send an updated target sensing task measurement report in aperiodic, periodic or semi-persistent form over a UL control or data channel. Further, for example, the WTRU determines to send the updated target sensing task measurement report in aperiodic, periodic or semi-persistent form over the UL control or data channel containing at least one of the following: time stamp of the updated measurements (e.g., in absolute or relative time, or number of slots, frames, or the like relative to a known reference); updated antenna ports involved in the measurements; updated reference signal resources employed in the measurements; updated sensing measurements and uncertainties; updated positioning measurements and uncertainties; new set of sensing and/or positioning measurements with uncertainties; updated error types; updated error sources; updated dependency measurements effect; updated association between sensing and positioning measurement objects, measurement index, or reports; updated validity window; combinations of the same; or the like.

In another example, the WTRU may be configured to report the invalidity of its sensing and/or positioning measurement report and/or measurement object to the network.

In some embodiments, WTRU reporting termination is provided. For example, the WTRU reporting termination includes exit and/or failure and/or termination conditions. Also, for example, the WTRU is configured to perform the measurements over multiple measurement occasions (e.g., multi-slot level, e.g., repetition factor, time gap configurations). Further, for example, the WTRU determines that reporting the sensing assisted positioning measurements and information can be terminated. In addition, for example, a determination, by the WTRU, that reporting the sensing assisted positioning measurements and information is to be terminated is based on at least one of the following: the determination of sensing error in one or more related positioning measurements below or above a preconfigured threshold for a configured threshold time or configured number of measurement occasions; the determination of positioning error in one or more related positioning measurements below or above a preconfigured threshold for a configured threshold time or configured number of measurement occasions; the determination of a certain measurement error flow in dependency and hierarchical measurements (e.g., having an error on RSRP measurements that would affect the AoA measurements that would affect the RCS measurements, this flow may be configured as unsolvable, and a termination is required); the determination of no change in one or more of the sensing measurements over a predefined period; the determination of no change in one or more of the positioning measures over a predefined period; the determination of no change in error types over a predefined period; the determination of no change in error sources over a predefined period; the determination of no change in one or more of the metrics or KPIs over a predefined period; achieving the sensing requirements over a predefined period; a time elapsed since the last reporting of precoding feedback information exceeding a maximum absolute or relative duration; a low-battery indication by the WTRU; a termination indication by the network; combinations of the same; or the like.

In a solution, based on any of the above, the WTRU may terminate the procedure of sensing assisted positioning and may send a report over a UL control or data channel containing the recommendation to terminate the measurement procedure. Also, for example, the WTRU may terminate the procedure and send the report including at least one of the following: termination indicator, termination time stamp, detailed termination reason, the latest sensing assisted positioning report, combinations of the same, or the like.

In one example, the termination indicator may refer to the reason of termination. For example, termination indicator=1 refers to error type does not change for N measurement occasions. While an indicator value=2 refers to determined error source for N measurement occasions.

Regarding the detailed termination reason, in one example, the WTRU may indicate that the error source is angle based. For example, the WTRU may further indicate that the angle based error source comprises an AoA measurements error, which is related to either low angular resolution or low RSRP, where the latter is due to presence of blockage or high interference.

Also, for example, the latest sensing assisted positioning report includes at least one of requested information, measurements performed, determined error types, determined error sources, existing triggering conditions, WTRU actions performed, time stamps, RS signal ID used for sensing, RS signal ID used for positioning, combinations of the same, or the like.

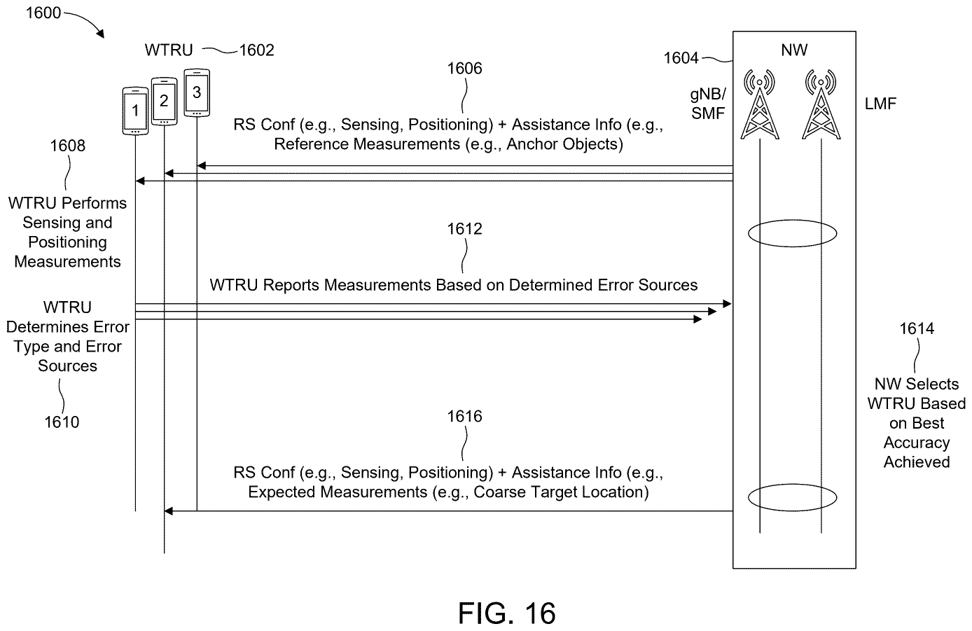

In certain representative embodiments, sensing measurement and/or error type and/or source determination are provided. FIG. 16 is a flowchart of a sensing assisted positioning procedure 1600 using multi-WTRU scenarios and separate NW entities to perform sensing and positioning. For example, the procedure 1600 involves one or more WTRUs 1602, or the like. Also, for example, the procedure 1600 involves NW 1604. Further, for example, the NW 1604 includes gNB/SMF and/or LMF. In addition, for example, the procedure 1600 includes transmitting 1606 an RS configuration (e.g., sensing, positioning, and the like) from the NW 1604 to at least one of the WTRUs 1602. Moreover, for example, the transmitting 1606 includes assistance information (e.g., reference measurements (e.g., anchor objects)). In the example of FIG. 16, each of three WTRUs 1602 receives the RS configuration.

Also, for example, the procedure 1600 includes, at each of the WTRUs 1602, performing 1608 one or more sensing and/or positioning measurements. Further, for example, the procedure 1600 includes, at each of the WTRUs 1602, determining 1610 one or more error types and/or one or more error sources. In addition, for example, the procedure 1600 includes, from each of the WTRUs 1602, transmitting 1612 one or more WTRU report measurements to the network 1604. Moreover, for example, the procedure 1600 includes selecting 1614, at the network 1604, at least one (e.g., or a set, or all) of the WTRUs 1602 based on an attribute, e.g., a preconfigured attribute such as a best accuracy achieved. Furthermore, for example, the procedure 1600 includes transmitting 1616 a revised RS configuration (e.g., sensing, positioning, and the like) from the NW 1604 to at least one of the WTRUs 1602. Additionally, for example, the transmitting 1616 includes assistance information (e.g., expected measurements (e.g., coarse target location)). In the example of FIG. 16, a selected one of three WTRUs 1602 (e.g., the WTRU achieving the best accuracy) receives the revised RS configuration.

The procedure 1600 provides, for example, reliable sensing measurement and/or error type and/or source determination. Also, for example, the procedure 1600 provides prioritization conditions between different procedures (e.g., sensing procedure, positioning procedure).

Numerous benefits are achieved by the methods and systems disclosed herein. The benefits include but are not limited to at least one of improved QoS, improved power savings, improved reporting overhead, enablement of new use cases for positioning and/or sensing, enablement of different endpoints for positioning and/or sensing, assisting the NW, combinations of the same, or the like.

For example, improved QoS is provided (e.g., sensing and/or positioning) achieving higher accuracy by detecting and resolving error types and sources.

Regarding the improved power saving, for example, additional benefits include an ability to not process positioning unless provided for reporting of sensing measurements, and/or an ability to not send measurements that are not useful. Also, for example, the WTRU performs positioning related to sensing only when sensing is in a specific state, or a signaling optimization. Further, for example, the WTRU can autonomously control how it performs positioning based on a sensing process avoiding providing for the NW to explicitly control and/or activate (or the like) the positioning and sensing configuration.

Regarding the improved reporting overhead over the NW, for example, useful measurements are sent by determining if the WTRU measurements are reliable or not.

For example, the new use cases are enabled that rely on sensing and/or positioning.

For example, the different endpoints are enabled for positioning and/or sensing protocols (e.g., LMF versus gNB).

Regarding the assisting of the NW in different aspects, the aspects include resource allocation for one or more WTRUs by providing the error sources and types, and/or determination of subnetwork issues by comparing reports from multiple WTRUs. For example, if a majority of the one or more WTRUs are reporting lack of integrity, the lack of integrity may correspond to an RS configuration issue, so the NW can change the configuration, use a different configuration, use additional pre and/or pro processing tools, or the like. Also, for example, if a majority of the one or more WTRUs are reporting lack of integrity, the lack of integrity may correspond to detection of jamming and/or security issues.

Further, for example, the determination of subnetwork issues by comparing reports from multiple WTRUs, includes determining if a lack of integrity is flagged up by a few WTRUs, which may indicate at least one of blockage and/or presence of one or more EOs for one or more certain WTRUs. In addition, for example, if a lack of integrity is flagged up by a few WTRUs, a service is stopped for the corresponding WTRUs for a given period. Moreover, for example, if a lack of integrity is flagged up by a few WTRUs, an RS reconfiguration may occur.

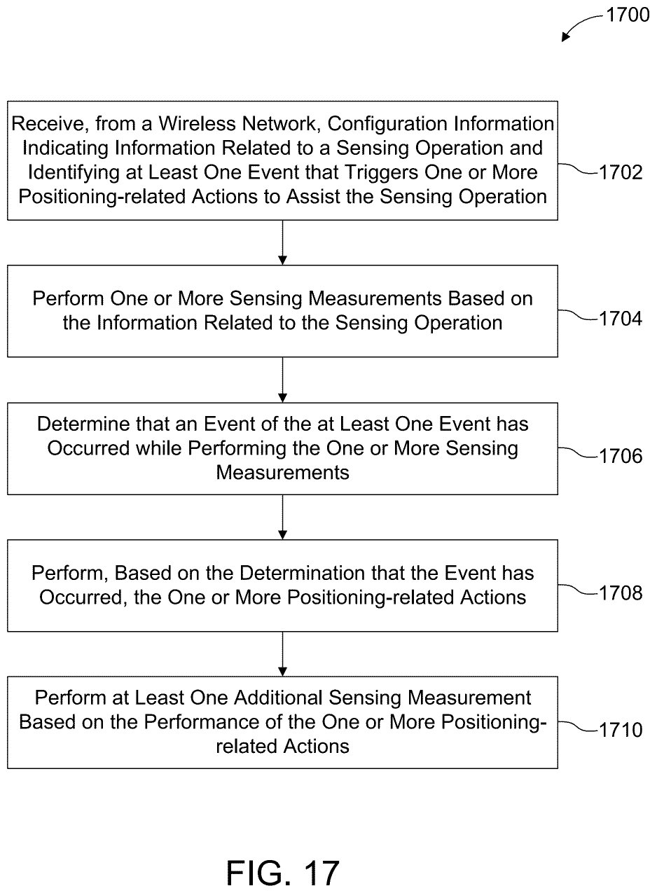

In certain representative embodiments, as shown, for example, in FIG. 17, a WTRU (e.g., 102, 302, 402, 502, 602, 702, 802, 1602, or the like) is provided in communication with a wireless network (e.g., core network 106, 115; network 304, 406, 408, 504; gNB 604; TRP 704, 804; network 1604; or the like). For example, a method 1700 is performed by the WTRU. Also, for example, the method 1700 comprises receiving 1702, from the wireless network, configuration information indicating information related to a sensing operation and identifying at least one event that triggers one or more positioning-related actions to assist the sensing operation. Further, for example, the method 1700 comprises performing 1704 one or more sensing measurements based on the information related to the sensing operation. In addition, for example, for example, the method 1700 comprises determining 1706 that an event of the at least one event has occurred while performing the one or more sensing measurements. Moreover, for example, the method 1700 comprises performing 1708, based on the determination that the event has occurred, the one or more positioning-related actions. Furthermore, for example, the method 1700 comprises performing 1710 at least one additional sensing measurement based on the performance of the one or more positioning-related actions.

Also, for example, the event is based on at least one of: changes in the one or more sensing measurements; hierarchical measurement dependencies; a determined error type or error source; reference values or expected values of the one or more sensing measurements; reliability of the one or more sensing measurements; or mobility of the WTRU.

Further, for example, the information related to the sensing operation comprises at least one of: a sensing target identifier; sensing target positioning information; a sensing target type; sensing target mobility information; WTRU positioning information; hierarchical measurements and dependencies; error sources, types, groups, or determination procedures; reference sensing measurements; thresholds for measurement validation; reporting assistance information; or a validity time.

In addition, for example, the method 1700 comprises transmitting, to the wireless network, assistance information based at least in part on the one or more sensing measurements. Moreover, for example, the method 1700 comprises receiving, from the wireless network, updated assistance information. Furthermore, for example, the method 1700 comprises repeating the first performing step 1704, the determining step 1706, the second performing step 1708, the third performing step 1710, the transmitting step (i.e., the transmitting, to the wireless network, assistance information based at least in part on the one or more sensing measurements), and the receiving step (i.e., the receiving, from the wireless network, updated assistance information) based on determining that a termination event does not exist. Additionally, for example, the method 1700 comprises transmitting, to the wireless network, a report based on the one or more sensing measurements based on determining that the termination event exists.

Still further, for example, the one or more positioning-related actions comprise at least one of: performing one or more positioning measurements; indicating a positioning method to the wireless network; performing a joint positioning method; activating carrier phased positioning (CPP) enhancement; applying fusion of RAT and non-RAT positioning; applying the non-RAT positioning; increasing a positioning measurement window; validating the one or more positioning measurements and determining a validity window; reporting of the one or more positioning measurements based on measurement validation; or determining reporting modes of the one or more positioning measurements based on the event.

Even further, for example, based on the event further triggering one or more sensing-related actions to assist the sensing operation, the method 1700 further comprises performing, based on the determination that the event has occurred, the one or more sensing-related actions. Yet further, for example, based on the event further triggering one or more sensing-related actions to assist the sensing operation, the method 1700 further comprises performing the at least one additional sensing measurement based on the performance of the one or more sensing-related actions.

Yet further, for example, the one or more sensing-related actions comprise at least one of: sending uplink assistance information to the wireless network; logging a first set of sensing measurements; stopping performing of sensing measurements; applying a different sensing configuration; enabling a second set of sensing measurements; validating the first set of sensing measurements and determining a validity window; reporting of the first set of sensing measurements based on measurement validation; or determining reporting modes of the first set of sensing measurements based on the event.

Also, for example, based on the configuration information further indicating information related to a positioning operation, the method 1700 further comprises performing one or more positioning measurements based on the information related to the positioning operation.

Further, for example, the determining that the event of the at least one event has occurred is based on the one or more positioning measurements.

In addition, for example, based on the configuration information further identifying an additional at least one event that triggers one or more sensing-related actions to assist the positioning operation, the method 1700 further comprises determining that an additional event of the additional at least one event has occurred while performing the one or more positioning measurements. Moreover, for example, based on the configuration information further identifying an additional at least one event that triggers one or more sensing-related actions to assist the positioning operation, the method 1700 further comprises performing, based on the determination that the additional event has occurred, the one or more sensing-related actions. Furthermore, for example, based on the configuration information further identifying an additional at least one event that triggers one or more sensing-related actions to assist the positioning operation, the method 1700 further comprises performing at least one additional positioning measurement based on the performance of the one or more sensing-related actions.

In some embodiments, a WTRU is configured to perform any combination of the above-referenced steps of the method 1700.

In some embodiments, a wireless network (e.g., core network 106, 115; network 304, 406, 408, 504; gNB 604; TRP 704, 804; network 1604; or the like), or a portion thereof (e.g., SMF 604, LMF 606, SMF and/or LMF of FIG. 16 (part of NW 1604); or the like), is configured to perform at least one of providing communication, sending configuration information, receiving assistance information, sending updated assistance information, receiving positioning method indications, receiving uplink assistance information, combinations of the same, or the like. For example, the wireless network establishes communication with a WTRU (e.g., 102, 302, 402, 502, 602, 702, 802, 1602, or the like). The wireless network sends configuration information to the WTRU, detailing the sensing operation and identifying events that trigger positioning-related actions. The wireless network receives assistance information from the WTRU, which is based on the sensing measurements. The wireless network then sends updated assistance information back to the WTRU. Additionally, the wireless network receives indications of the positioning method from the WTRU. Finally, the wireless network receives uplink assistance information from the WTRU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving, from a wireless network, configuration information indicating information related to a sensing operation and identifying at least one event that triggers one or more positioning-related actions to assist the sensing operation;
performing one or more sensing measurements based on the information related to the sensing operation;
determining that an event of the at least one event has occurred while performing the one or more sensing measurements;
performing, based on the determination that the event has occurred, the one or more positioning-related actions; and
performing at least one additional sensing measurement based on the performance of the one or more positioning-related actions.

2. The method of claim 1, wherein the event is based on at least one of:
changes in the one or more sensing measurements;
hierarchical measurement dependencies;
a determined error type or error source;
reference values or expected values of the one or more sensing measurements;
reliability of the one or more sensing measurements; or
mobility of the WTRU.

3. The method of claim 1, wherein the information related to the sensing operation comprises at least one of:
a sensing target identifier;
sensing target positioning information;
a sensing target type;
sensing target mobility information;
WTRU positioning information;
hierarchical measurements and dependencies;
error sources, types, groups, or determination procedures;
reference sensing measurements;
thresholds for measurement validation;
reporting assistance information; or
a validity time.

4. The method of claim 1, further comprising:
transmitting, to the wireless network, assistance information based at least in part on the one or more sensing measurements;
receiving, from the wireless network, updated assistance information;
repeating the performing one or more sensing measurements based on the information related to the sensing operation, the determining that the event of the at least one event has occurred while performing the one or more sensing measurements, the performing, based on the determination that the event has occurred, the one or more positioning-related actions, the performing at least one additional sensing measurement based on the performance of the one or more positioning-related actions, the transmitting, to the wireless network, assistance information based at least in part on the one or more sensing measurements, and the receiving, from the wireless network, updated assistance information based on determining that a termination event does not exist; and
transmitting, to the wireless network, a report based on the one or more sensing measurements based on determining that the termination event exists.

5. The method of claim 1, wherein the one or more positioning-related actions comprise at least one of:
performing one or more positioning measurements;
indicating a positioning method to the wireless network;
performing a joint positioning method;
activating carrier phased positioning (CPP) enhancement;
applying fusion of radio access technology (RAT) and non-RAT positioning;
applying the non-RAT positioning;
increasing a positioning measurement window;
validating the one or more positioning measurements and determining a validity window;
reporting of the one or more positioning measurements based on measurement validation; or
determining reporting modes of the one or more positioning measurements based on the event.

6. The method of claim 1, wherein the event further triggers one or more sensing-related actions to assist the sensing operation, further comprising:
performing, based on the determination that the event has occurred, the one or more sensing-related actions; and
performing the at least one additional sensing measurement based on the performance of the one or more sensing-related actions.

7. The method of claim 6, wherein the one or more sensing-related actions comprise at least one of:
sending uplink assistance information to the wireless network;
logging a first set of sensing measurements;
stopping performing of sensing measurements;
applying a different sensing configuration;
enabling a second set of sensing measurements;
validating the first set of sensing measurements and determining a validity window;
reporting of the first set of sensing measurements based on measurement validation; or
determining reporting modes of the first set of sensing measurements based on the event.

8. The method of claim 1, wherein the configuration information further indicates information related to a positioning operation, further comprising:
performing one or more positioning measurements based on the information related to the positioning operation.

9. The method of claim 8, wherein the determining that the event of the at least one event has occurred is based on the one or more positioning measurements.

10. The method of claim 8, wherein the configuration information further identifies an additional at least one event that triggers one or more sensing-related actions to assist the positioning operation, further comprising:
determining that an additional event of the additional at least one event has occurred while performing the one or more positioning measurements;
performing, based on the determination that the additional event has occurred, the one or more sensing-related actions; and
performing at least one additional positioning measurement based on the performance of the one or more sensing-related actions.

11. A wireless transmit/receive unit (WTRU) comprising:
a processor; and
a transceiver, wherein the WTRU is configured to:
receive, from a wireless network, configuration information indicating information related to a sensing operation and identifying at least one event that triggers one or more positioning-related actions to assist the sensing operation;
perform one or more sensing measurements based on the information related to the sensing operation;
determine that an event of the at least one event has occurred while performing the one or more sensing measurements;
perform, based on the determination that the event has occurred, the one or more positioning-related actions; and
perform at least one additional sensing measurement based on the performance of the one or more positioning-related actions.

12. The WTRU of claim 11, wherein the event is based on at least one of:
changes in the one or more sensing measurements;
hierarchical measurement dependencies;
a determined error type or error source;
reference values or expected values of the one or more sensing measurements;
reliability of the one or more sensing measurements; or
mobility of the WTRU.

13. The WTRU of claim 11, wherein the information related to the sensing operation comprises at least one of:
a sensing target identifier;
sensing target positioning information;
a sensing target type;
sensing target mobility information;
WTRU positioning information;
hierarchical measurements and dependencies;
error sources, types, groups, or determination procedures;
reference sensing measurements;
thresholds for measurement validation;
reporting assistance information; or
a validity time.

14. The WTRU of claim 11, wherein the WTRU is further configured to:
transmit, to the wireless network, assistance information based at least in part on the one or more sensing measurements;
receive, from the wireless network, updated assistance information;
repeat the performing one or more sensing measurements based on the information related to the sensing operation, the determining that the event of the at least one event has occurred while performing the one or more sensing measurements, the performing, based on the determination that the event has occurred, the one or more positioning-related actions, the performing at least one additional sensing measurement based on the performance of the one or more positioning-related actions, the transmitting, to the wireless network, assistance information based at least in part on the one or more sensing measurements, and the receiving, from the wireless network, updated assistance information based on determining that a termination event does not exist; and
transmit, to the wireless network, a report based on the one or more sensing measurements based on determining that the termination event exists.

15. The WTRU of claim 11, wherein the one or more positioning-related actions comprise at least one of:
performing one or more positioning measurements;
indicating a positioning method to the wireless network;
performing a joint positioning method;
activating carrier phased positioning (CPP) enhancement;
applying fusion of radio access technology (RAT) and non-RAT positioning;
applying the non-RAT positioning;
increasing a positioning measurement window;
validating the one or more positioning measurements and determining a validity window;
reporting of the one or more positioning measurements based on measurement validation; or
determining reporting modes of the one or more positioning measurements based on the event.

16. The WTRU of claim 11, wherein the event further triggers one or more sensing-related actions to assist the sensing operation, and wherein the WTRU is further configured to:
perform, based on the determination that the event has occurred, the one or more sensing-related actions; and
perform the at least one additional sensing measurement based on the performance of the one or more sensing-related actions.

17. The WTRU of claim 16, wherein the one or more sensing-related actions comprise at least one of:
sending uplink assistance information to the wireless network;
logging a first set of sensing measurements;
stopping performing of sensing measurements;
applying a different sensing configuration;
enabling a second set of sensing measurements;
validating the first set of sensing measurements and determining a validity window;
reporting of the first set of sensing measurements based on measurement validation; or
determining reporting modes of the first set of sensing measurements based on the event.

18. The WTRU of claim 11, wherein the configuration information further indicates information related to a positioning operation, and wherein the WTRU is further configured to:
perform one or more positioning measurements based on the information related to the positioning operation.

19. The WTRU of claim 18, wherein the WTRU configured to determine that the event of the at least one event has occurred is based on the one or more positioning measurements.

20. The WTRU of claim 18, wherein the configuration information further identifies an additional at least one event that triggers one or more sensing-related actions to assist the positioning operation, and wherein the WTRU is further configured to:
determine that an additional event of the additional at least one event has occurred while performing the one or more positioning measurements;
perform, based on the determination that the additional event has occurred, the one or more sensing-related actions; and
perform at least one additional positioning measurement based on the performance of the one or more sensing-related actions.
